(19) United States
(12) Patent Application Publication
(10) Pub. No.: US 2026/0064978 A1
(43) Pub. Date: Mar. 5, 2026

(54) CONTROLLABLE TEXT GENERATION OPTIMIZED FOR FLUENCY AND METRIC SCORES

(71) Applicant: Adobe Inc., San Jose, CA (US)

(72) Inventors: An YAN, San Jose, CA (US); Zhao Song, San Jose, CA (US); Tong Yu, San Jose, CA (US); Ritwik Sinha, Cupertino, CA (US); Raghavendra Kiran Addanki, Santa Clara, CA (US); David Arbour, San Jose, CA (US); Chinedu Ojukwu, San Jose, CA (US)

(21) Appl. No.: 18/821,636

(22) Filed: Aug. 30, 2024

(51) Int. Cl. G06F 40/40

(52) U.S. Cl. CPC G06F 40/40

(57) ABSTRACT

Various disclosed embodiments are directed to controllable text generation that is optimized for natural language fluency and particular conditions, such as specific metrics. In other words, various embodiments generate text that is both fluent and predicted to meet particular metric scores. For example, various embodiments generate text that is not only concise and human-readable, but also is associated with particular user engagement metric scores, such as a high click rate or the like.

### BACKGROUND

Controllable text generation is a natural language processing technique that influences or directs the output of language models according to specific criteria or conditions. This capability allows models to guide the generated text to meet certain requirements or preferences, making the output more useful and relevant for various applications. Currently, it is still challenging for existing technologies to generate human-readable text that aligns with human preferences or other conditions (e.g., specific sentiment, detoxification, attractiveness, and human satisfaction,), even with the recent advance of Large Language Models (LLMs).

Existing technologies for controllable text generation often struggle with balancing natural language fluency of generated text with specific conditions. Natural language fluency refers to the ability of generated text to read smoothly and coherently, mimicking the way a human naturally writes or speaks. Fluent text is grammatically correct, logically structured, and contextually appropriate, making it easy to understand and engaging for readers. Additionally, existing technologies are computationally expensive (e.g., in terms of memory consumption and latency), requiring significant computing resources to fine-tune and optimize, which limits their practicality and scalability for real-world applications, as described in more detail below.

### SUMMARY

One or more embodiments are directed to controllable text generation that is optimized for natural language fluency and particular conditions, such as specific metrics (e.g., a quantity of clicks, conversion rates, sentiment, etc.). In other words, various embodiments generate text that is both fluent and predicted to meet particular metric scores. For example, various embodiments generate text that is not only concise and human-readable, but also is associated with particular user engagement metric scores, such as a high click rate, or the like.

In operation, some embodiments first receive a dataset, such as text-metric score pairs (e.g., email messages with open rates for opening the email messages). Some embodiments then provide a metric value model the dataset as input such that the metric value model predicts one or more metric scores with text as input. For example, for a particular block of text, some embodiments predict a click rate, which indicates how likely a user is to click on the text. Some embodiments then provide a language model (e.g., a Large Language Model) the metric value model as a scoring function and a text prompt as input such that the language model generates candidate text sequences. This means that the language model uses the metric scores predicted by the value model to guide the text generation and optimization process. Each generated candidate sequence is passed through the metric value model, which evaluates and assigns a metric score based on predefined metrics (e.g., click-through rates, user satisfaction).

Some embodiments then convert the candidate text sequences generated by the language model to a text embedding (e.g., a vector representation). Various embodiments then optimize (e.g., via batched KL divergence) the text embedding by taking gradients of the score function with one or more constraints to cause natural language fluency. Various embodiments additionally or alternatively use a periodic weighted factor to control whether there is a change at each token position of the text embedding. For example, various embodiments perform sparse weighting by assigning lower gradients to most positions in the text sequence, focusing significant updates only on key positions. This effectively changes only a few columns in a matrix representing the text embedding. This selective updating helps in maintaining the overall structure and coherence of the text, leading to better natural language fluency.

Various embodiments of the present disclosure have various technical effects and improvements over existing text generation technologies, such as Large Language Models (LLMs). For example, some technical effects include improved accuracy, reduced memory consumption, improved processor utilization, improved throughput, and reduced latency, as described in more detail herein.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. The present invention is described in detail below with reference to the attached drawing figures, wherein:

FIG. 1 is a schematic diagram illustrating, at a high level, how email text is generated that is both fluent and predicted to have a high click rate, according to some embodiments;

FIG. 2 is a block diagram illustrating aspects of an example computing system architecture, according to some embodiments;

FIG. 3 is a block diagram of an example pipeline for optimizing a set of metric constraints as a distribution over text in the form of energy-based models (EBMs) to generate fluent and engaging text, according to some embodiments;

FIG. 4 is a schematic diagram illustrating how multiple anchor points are used for batched KL Divergence, according to some embodiments;

FIG. 5 represents a pipeline illustrating altering only a few key words of the language model output via a sparse weighting function, according to some embodiments;

FIG. 6 depicts a diagram of an example neural network that is trained to generate one or more metric scores, text, and/or next word distributions, according to some embodiments;

FIG. 7 is a screenshot of an example page of a user interface for generating optimized text, according to some embodiments;

FIG. 8 is a flow diagram of an example process for optimizing a text embedding of a language model, according to some embodiments;

FIG. 9 is a flow diagram of an example process for changing or optimizing a set of text based on a divergence measure, according to some embodiments;

FIG. 10A is a chart illustrating improvements over existing technologies with respect to sentiment metrics, according to some embodiments;

FIG. 10B is a chart illustrating improvements over existing technologies with respect to perplexity or natural language fluency, according to some embodiments;

FIG. 11 is an example computer environment in which aspects of the present disclosure are employed, according to some embodiments; and

FIG. 12 is a block diagram of a computing device in which aspects of the present disclosure employ, according to some embodiments.

### DETAILED DESCRIPTION

### Overview

As described above, existing technologies for controllable text generation struggle with balancing natural language fluency of generated text with specific desired conditions. Traditional language models (e.g., LLMs), for example, focus primarily on generating fluent text without specific optimization for engagement or other metrics (e.g., click rates). Generating text that is merely fluent (i.e., grammatically correct, logically structured, and contextually appropriate) without optimizing for specific conditions can lead to several technical problems. These issues arise because fluency alone does not guarantee that the text will achieve desired outcomes such as high user engagement, high sentiment, or other condition. In other words, although the text generation may be fluent, it is not accurate because it still does not fulfill the specified condition.

Some existing technologies also use simple condition optimization techniques without requiring natural language fluency. However, technologies that optimize or sample solely for conditioning often produce text that fulfills certain conditions but lacks natural language fluency. For example, after several iterations of optimization, the quality of the generated text degrades considerably with particular models. The text becomes less fluent, grammatically incorrect, or even non-human-readable. In other words, the quality of natural language text diminishes considerably with the use of simple condition optimization techniques.

Existing technologies also unnecessarily consume computing resources, such as memory, CPU, and latency. For example, during optimization, existing technologies update every word or token in the sequence or column in a word embedding, which leads to unnecessary computations, especially when only a few parts of the sequence require changes. The impact is unnecessary computing resource consumption memory, processing, and latency. For instance, existing technologies store gradients and other intermediate states for all tokens, leading to excessive memory consumption. There is also a higher computational (e.g., CPU/GPU) cost due to updating all parameters instead of focusing on the most impactful ones. There is also increased latency per training iteration and slower convergence.

Additionally existing technologies have a lack of targeted optimization leading to unnecessary computing resource consumption. Optimizing models without focusing on specific metrics like engagement or fluency can lead to over-computation and less effective outcomes. There is a negative impact on memory, for example, because there are additional storage requirements for models and datasets that might not be directly relevant to the desired outcome. There are also more extensive computations as the model tries to cover all possible aspects rather than focusing on targeted improvements. Further, there may be longer training and inference times due to the broad scope of optimization.

Moreover, existing technologies employ inefficient sampling methods leading to unnecessary computing resource consumption. Existing technologies use inefficient sampling methods, such as greedy or unoptimized sampling, which can lead to suboptimal text generation that requires additional post-processing or multiple iterations to achieve desired quality. Consequently, there is extra computer storage requirements for multiple generated samples and intermediate results. There is also increased computational effort due to generating and evaluating multiple versions of the text. There is also longer overall generation time as the model iteratively refines the output.

Embodiments of the present disclosure provide one or more technical solutions to one or more of these technical problems, as described herein. Various aspects are directed to controllable text generation that is optimized for natural language fluency and particular conditions, such as specific metrics (e.g., quantity of clicks, conversion rates, sentiment, etc.). In other words, various embodiments generate text that is both fluent and predicted to meet particular metric scores. For example, various embodiments generate text that is not only concise and human-readable, but also is associated with particular user engagement metric scores, such as a high click rate, or the like.

In operation, some embodiments first access a dataset that includes a set of natural language sequences and a respective metric associated with each natural language sequence. For example, each natural language sequence may correspond to given email subject lines and the respective metric may be a particular open rate that indicates the percentage of email recipients who opened a corresponding email. Based on the first set of natural language characters and the respective metric associated with each natural language sequence, some embodiments then generate, via a language model, a batch of natural language sequences. In some embodiments, the generating of the batch of natural language sequence is based on computing, via a value model, a metric score for each natural language sequence of the batch of natural language sequences. The metric score is indicative of how well a respective natural language sequence of the batch of natural language sequences is expected to perform according to a given metric. For example, the value model may be trained on the dataset to predict scores with the dataset as input. In various embodiments, the value model is used as a score function to guide the language mode to produce the batch of natural language sequences, as described in more detail below.

Various embodiments then encode the batch of natural language sequences into a first text embedding that at least partially represents the natural language sequences. For example, an encoder can convert the natural language sequences) into a numerical format (e.g., dense vector) that a machine learning model can process.

Some embodiments then use a distribution difference function (e.g., KL Divergence) as a condition/constraint that encourages natural language fluency. For example, for each word of each natural language sequence of the batch of natural language sequences, some embodiments compute a degree of deviation between a predicted distribution of a next word and multiple anchor points. Each anchor point represents a reference distribution generated by the language model for maintaining natural language fluency. These distributions are used to measure how much the predicted distribution of the next word in a sequence diverges from what is considered fluent and natural. For example, there may be a batch of two sequences (sentences): “The quick brown fox” and “Jumps over the lazy dog.” For each position or word in the sequences, the language model predicts the next word. For instance, for the sequence “The quick brown fox,” at position 1 (“The”), the model predicts a probability distribution for the next word (e.g., “quick” might have a high probability, while “dog” might have a low probability). The reference distribution (i.e., the anchor points) is the language model's predicted probability distribution for the next word based on the preceding context. It represents what the language model considers as natural or fluent text.

In an illustrative example, for the word “quick” following “The” in the sequence “The quick brown fox,” the reference distribution might look like: “quick”: 0.8, “slow”: 0.1, “fox”: 0.05, “dog”: 0.05. For each step in the sequence, some embodiments compare the predicted distribution to the reference distribution to calculate batched KL divergence. This measures how much the predicted probabilities diverge from what the language model considers natural. For example, if the current sequence being generated diverges significantly or over a threshold from the reference distribution (e.g., predicting “dog” with high probability instead of “quick”), the KL divergence will be high.

Based on at least one metric (e.g., sentiment, attractiveness, popularity, a quantity of clicks, a click-through rate (CTR), etc.) and the degree of deviation between the predicted distribution of the next word and the plurality of anchor points, some embodiments change the input text embedding into a second text embedding (e.g., resulting in a change of one or more words of the natural language sequences). For example, in some embodiments, the changing represents optimization of an energy-based model that minimizes an energy function for the changing of the first text embedding to the second text embedding. And minimizing the energy function includes generating natural language text that optimized for a metric while remaining fluent, as described in more detail below.

In some embodiments, the change is additionally or alternatively based on assigning a low gradient to most positions in the first text embedding and introducing a periodic weighted factor that controls the change at each position of the first text embedding when generating the second text embedding. This selective updating helps in maintaining the overall structure and coherence of the text, leading to better natural language fluency. The periodic weighted factor applies systematic control over the updates at each position, preventing overfitting and ensuring stable optimization. This weighted factor thus helps in focusing the updates on certain positions more than others in a periodic fashion, allowing the model to make more significant changes where necessary while maintaining stability in other parts. This controlled approach ensures that the generated text maintains fluency and coherence. For example, some embodiments only change 1 or 2 columns in a matrix representing a text embedding, which effectively only changes a few words in a sentence.

Aspects of the present disclosure employ various technical solutions that have technical effects. For example, one technical solution is using a divergence component (e.g., computing a degree of deviation between a predicted distribution of a next word and a plurality of anchor points, such as batched KL divergence) and/or a weighted factor component (e.g., assigning a low gradient to most positions in the first text embedding and/or introducing a periodic weighted factor) for better natural language fluency and higher quality text that is more likely to meet particular metrics. In other words, various embodiments improve text generation technologies by balancing natural language fluency of generated text with specific desired metric-based conditions. For example, some embodiments improve traditional language models (e.g., LLMs) because these embodiments do not focus solely on generating fluent text, but generate text with specific optimization for engagement or other metrics (e.g., click rates). As described above, fluency alone does not guarantee that the text will achieve desired outcomes such as high user engagement, high sentiment, or other condition. In other words, various embodiments improve the accuracy of language models because these embodiments do not just generate text that is fluent, these embodiments generate text that fulfills specified conditions (e.g., generate text likely to have a high click rate).

Some embodiments also improve simple condition optimization technologies. As described above, these technologies optimize or sample solely for conditioning, which produce text that fulfills certain conditions but lacks natural language fluency. In other words, the quality of natural language text diminishes considerably with the use of simple condition optimization techniques. However, by incorporating a divergence component and/or a weighted factor component, various embodiments not only generate text that fulfills certain conditions, but employs a high degree of natural language fluency.

Other technical effects include reduced memory consumption, improved processor utilization, improved throughput, and reduced latency. With respect to reduced memory consumption, employing the weighted factor component (e.g., sparse weighting function) reduces memory consumption. For example, by assigning lower gradients to most positions and focusing updates only on key positions, the model reduces the number of parameters that need to be actively updated and stored in memory. This selective updating minimizes memory usage. The impact is that there is less memory required to store and process gradients, leading to more efficient memory usage during training or deployment.

Efficient gradient computations also lead to reduced processor (e.g., CPU/GPU) utilization. Sparse weighting reduces the computational load on CPUs and GPUs because fewer gradient computations are needed. By focusing updates on fewer positions, the number of operations required for each iteration (e.g., training step) is reduced. The impact is Lower CPU/GPU usage per training or runtime iteration, allowing for faster processing times and the ability to train on larger datasets or more complex models within the same hardware constraints. By making significant updates only where necessary and using techniques like the periodic weighted factor for systematic control, the model can converge faster to an optimal solution. This means fewer iterations are needed to achieve high performance. The impact is higher throughput as the model requires fewer epochs to train effective, resulting in reduced overall training or inference time.

Various embodiments also have the technical effect of reduced memory consumption and latency because they employ targeted optimization by focusing on specific metrics like engagement or fluency. This leads to less computation and more effective outcomes. There is a reduced impact on memory consumption, for example, because there are no additional storage requirements for models and datasets that are not directly relevant to the desired outcome. In other words, one technical solution is the use of metric scores by a language model to generate text (e.g., based on the model using a value model as a scoring function). This ensures that the model optimizes for particular metrics, which means that the model refrains from using datasets unrelated to such metrics, which has the effect of reduced latency and less memory consumption.

Moreover, various embodiments improve existing technologies by employing efficient sampling methods (e.g., energy-based sampling methods) leading to reduced computing resource consumption. As described above, greedy or unoptimized sampling leads to suboptimal text generation that requires additional post-processing or multiple iterations to achieve desired quality leading to extra computer storage requirements for multiple generated samples and intermediate results. However, various embodiments use efficient sampling methods, such as energy-based sampling. Energy-based sampling in the context of some embodiments described herein involves computing and minimizing an energy function that captures both the desired metrics (e.g., engagement) and constraints like fluency. This targeted approach allows the model to focus its computational resources on the most impactful changes, rather than exhaustively sampling or updating all possible outputs. This leads to reduced memory consumption. By working directly with text embeddings and focusing on minimizing the energy function, energy-based models can represent and manipulate text in a lower-dimensional space compared to methods that handle all possible outputs. This reduces the need to store extensive intermediate representations or outputs, saving memory. For instance, unlike greedy methods that may require storing multiple candidate outputs or performing extensive computations to evaluate each one, energy-based sampling iteratively refines a single representation. This iterative refinement reduces the memory footprint and computational load.

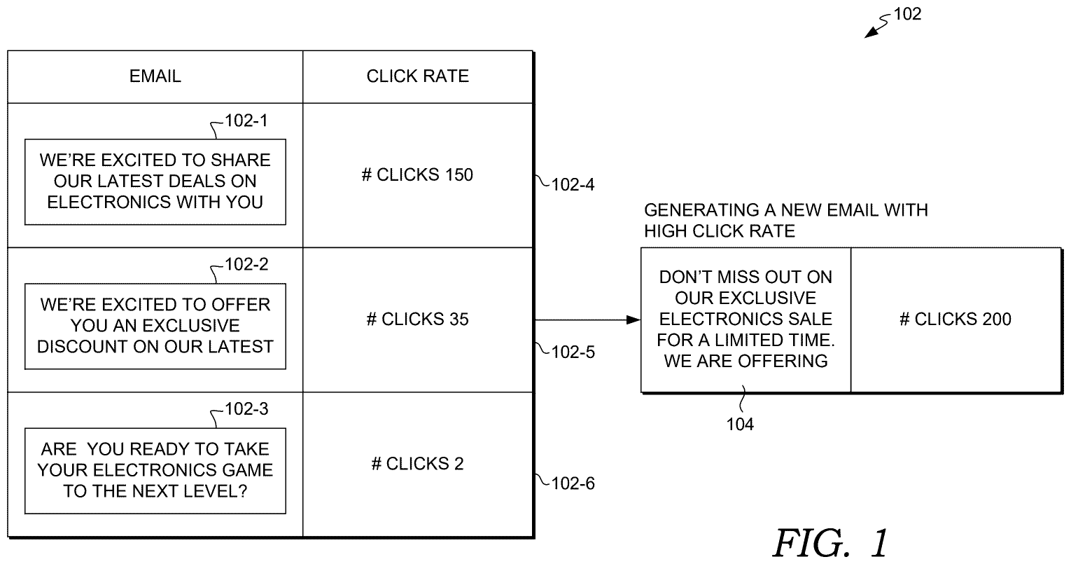

Turning now to the figures, FIG. 1 is a schematic diagram illustrating, at a high level, how email text is generated that is both fluent and predicted to have a high click rate, according to some embodiments. FIG. 1 includes a dataset (e.g., a data structure) 102, which includes a column of different emails (the text in a body of an email) 102-1, 102-2, and 102-3, as well as a column of different actual corresponding click rates 102-4, 102-5, and 102-6. For example, a data record may include the email 102-1 with a click rate of 150, indicating that one or more users clicked on one or more elements (a link) within the email 102-1 at a quantity of 150 times. FIG. 1 further includes controllable text generation of natural language characters 104, which are predicted to be associated with a click rate of 200 (which is higher than any other click rates in the dataset 102). Accordingly, based on the dataset 102 (e.g. an energy-based model training on the dataset 102), various embodiments generate the text 104, which is predicted to have a click rate of 200. Therefore, various embodiments of the present disclosure both generate fluent text and optimize for particular metric scores, such as high click rates as illustrated in FIG. 1, as described in more detail below.

In some embodiments, the dataset 102 represents actual data from real user engagement inputs on particular platforms, such as electronic marketplaces, email platforms, or the like. Such user engagement may be tracked in any suitable manner. For example, instead of direct URLs, emails may contain tracking links. These links redirect to the actual destination after recording the click event. In some embodiments, these tracking links are generated and managed by email marketing platforms or tracking services. For example, a direct URL like “https://example.com/special-offer” is converted into a tracking link like “https://tracker.example.com/click?url=https://example.com/special-offer&uid=12345.” When a recipient clicks on the tracking link, a request to a tracking server, may occur, where the tracking link directs the user's browser to the tracking server first.

The tracking server may then logs the click event. The log entry typically includes a unique identifier for the recipient (e.g., uid=12345). Other information, such as a timestamp of the click may also be recorded. User agent information (to identify the device and browser) may further be extracted. After logging the click, the tracking server redirects the user's browser to the original target URL (e.g., https://example.com/special-offer). The logged click data is stored in a database or other data store represented by the dataset 102. In some embodiments, however, at least a portion of the dataset 102 represents a set of synthetic or artificial emails and/or click rates generated by a programmer instead of actual user engagement data.

### Example System

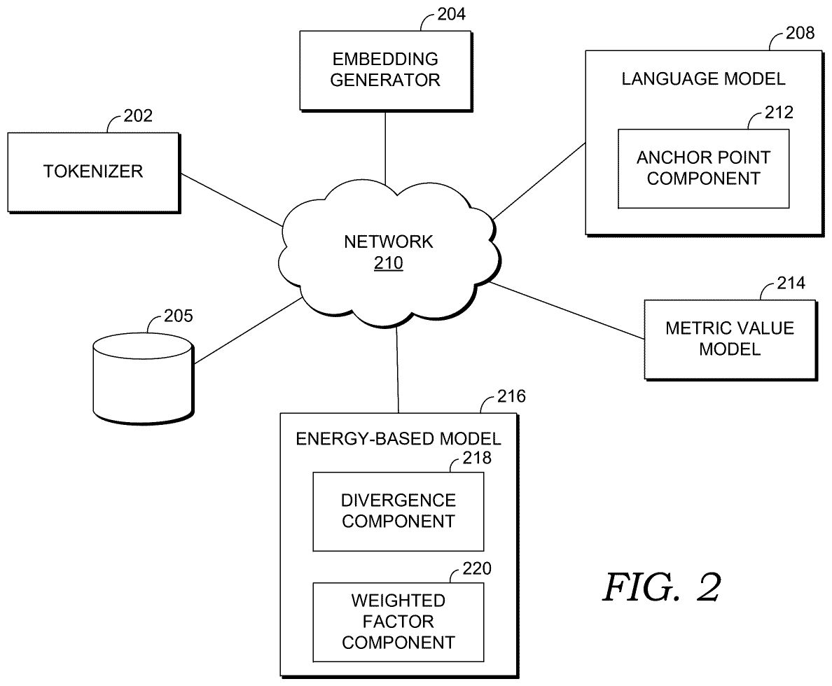

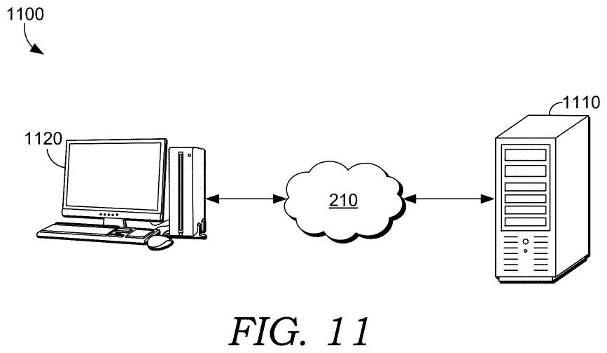

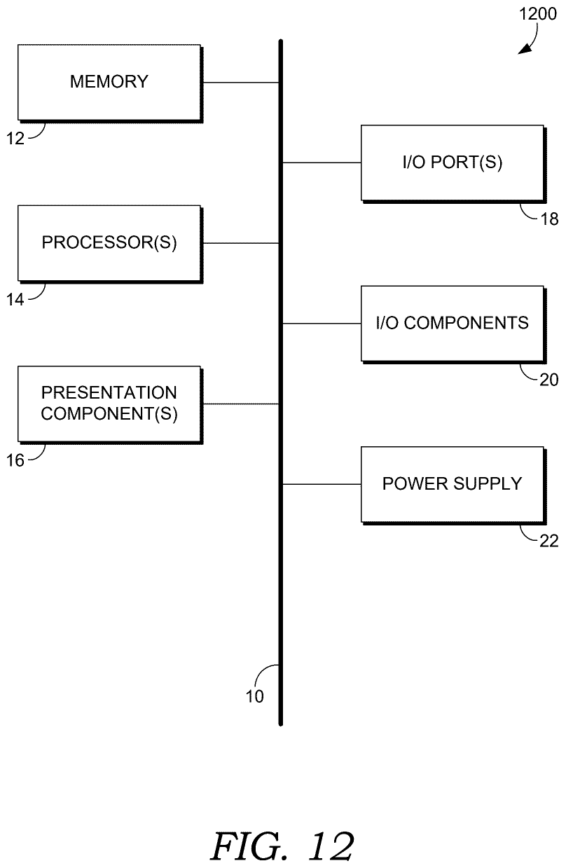

Referring now to FIG. 2, a block diagram is provided showing aspects of an example computing system architecture suitable for implementing an embodiment of the disclosure and designated generally as the system 200, according to some embodiments. The system 200 represents only one example of a suitable computing system architecture. Other arrangements and elements can be used in addition to or instead of those shown, and some elements may be omitted altogether for the sake of clarity. Further, many of the elements described herein are functional entities that may be implemented as discrete or distributed components or in conjunction with other components, and in any suitable combination and location. For example, some or each of the components of the system may be located within a single computing device (e.g., the computing device 1200 of FIG. 12). Alternatively, some or each of the components may be distributed among various computing devices, such as in a distributed cloud computing environment. In some embodiments, the system 200 and each of the components are located within the server and/or user device of FIG. 11, as described in more detail herein.

The system 200 includes network(s) 210, which is described in connection to FIG. 12, and which communicatively couples components of system 100, including a tokenizer 202, an embedding generator 204, an encoder 206, a language model 208, a metric value model 214, an energy-based model 216, and storage 105. The components of the system 200 may be embodied as a set of compiled computer instructions or functions, program modules, computer software services, logic gates, hardware accelerators, or an arrangement of processes carried out on one or more computer systems. The system 200 generally operates to generate text that is both fluent and meets particular metric scores or thresholds.

The tokenizer 202 is generally responsible for tokenizing natural language characters or text (e.g., generated by the language model 208 or represented by the dataset 102). Tokenizing natural language text is preprocessing step for language models. It involves converting a string of text into smaller units called tokens, which can be words, sub-words, or other characters. This process enables the language model to effectively handle and analyze the text. Tokenization can first involve text normalization, which involves cleaning and standardizing the text. It may include converting text to lowercase, removing punctuation, and handling special characters. The core step where the text is split into tokens. Depending on the model and its requirements, this can be done at different levels, such as Word-level Tokenization (Splits text into individual words), Sub-word-level Tokenization (Splits text into meaningful sub-words), or Character-level Tokenization (splits text into individual characters).

Each token is then mapped to a unique identifier (ID) from a predefined vocabulary. The vocabulary is a collection of all possible tokens that the model can understand. Since language models often work with fixed-length input, sequences are padded (with a special padding token) or truncated to fit the required length. In some models, tokens are further annotated with token type IDs (for tasks like question-answering) and positional encodings (to capture the position of each token in the sequence). In an illustrative example, for work-level tokenization for a sentence like “Hello, how are you?” the tokenization may be: [“hello”, “,”, “how”, “are”, “you”, “?”]. This process converts natural language text into a format that can be fed into a language model for various tasks such as text generation, classification, or translation.

The embedding generator 204 is generally responsible for generating one or more text embeddings that represents natural language text tokenized by the tokenizer 202. Text embeddings are numerical representations (e.g., dense vector representations) of text (e.g., natural language words, phrases, or sentences) that capture semantic meaning. These vectors are used as inputs to downstream machine learning models for various tasks such as classification, clustering, and retrieval. Some embodiments use a pre-trained language model to encode the tokenized natural language characters into dense vector representations. These embeddings represent the semantic and contextual information of the text. To generate initial distribution (soft sequences), for each position in the tokenized natural language sequence, the model generates a probability distribution over the next possible words. This distribution is influenced by the context provided by the preceding words. The result is a “soft sequence,” where each position is represented by a probability distribution rather than a single deterministic word. For example, for the tokenized sequence: [“The”, “quick”, “brown”, “fox”] For each position in the sequence, the model generates a probability distribution over the next possible words, such as Position 1: Context: [“The”] Generated Probability Distribution for the next word: “quick”: 0.5; “slow”: 0.2; “red”: 0.1 “lazy”: 0.1; “sleepy”: 0.1; Position 2: Context: [“The”, “quick”]; Generated Probability Distribution for the next word: “brown”: 0.6 “fox”: 0.2 “dog”: 0.1 “cat”: 0.05 “rabbit”: 0.05. For each position in the tokenized sequence, the model uses the preceding words to generate a probability distribution over possible next words. This sequence of distributions constitutes a “soft sequence,” representing multiple possible continuations at each step rather than a single deterministic word. This approach allows for flexibility and nuance in text generation, as the model considers various potential next words influenced by the context provided by the preceding words.

In some embodiments, the embedding generator 204 alternatively or additionally generates text embeddings using pre-trained models (e.g., Word2Vec, GloVe, FastText, or transformers like BERT, GPT, etc.) These models learn to map each token (word, subword, or sentence) to a vector in a high-dimensional space where semantically similar tokens are located close to each other.

The language model 208 (e.g., an LLM) is generally responsible for taking, as input, the text embeddings produced by the embedding generator 204 feedback from the metric value model 214 (or the metric value model itself), and/or feedback from the energy-based model 216 as described below) to generate text (e.g., predict a sequence of natural language words). The language model 208, for example, generates coherent and contextually relevant text based on a given prompt or context. For example, given the prompt “Once upon a time,” (as represented in the text embedding), the model might generate “there was a brave knight who set out on an adventure.” In some embodiments, the language model 208 performs probability estimation, which estimates the likelihood of a given sequence of words, which helps in generating text that follows natural language patterns. For example, the language model 208 determines that the sequence “The cat sat on the mat” is more probable than “The cat sat mat on the.”

The language model 208 further engages in context understanding by understanding the context of the given text to generate relevant and meaningful responses or continuations. For example, if the context is a conversation about food, it will generate responses related to food.

The language model 208 includes an anchor point component 212, which plays a role in ensuring the generated text is both engaging (meets specific metric criteria) and fluent. Anchor points are reference distributions generated by a pre-trained language model, such as the language model 208. They serve as benchmarks for maintaining natural language fluency during the text generation process. Reference distributions provide reference probability distributions for the next word in a sequence, representing fluent and natural language continuations. For example, for the context “The quick brown fox,” the anchor points might provide the distribution: {“jumps”: 0.7, “runs”: 0.2, “sleeps”: 0.05, “eats”: 0.05}. The anchor point component 212 ensures that the generated text remains close to natural language patterns by comparing the predicted distributions to the anchor points. For example, if the predicted distribution for the next word is {“jumps”: 0.4, “runs”: 0.3, “sleeps”: 0.2, “eats”: 0.1}, the model will adjust its prediction to be closer to the anchor points.

The metric value model 214 is generally responsible for generating or predicting metric scores using an original dataset (e.g., the dataset 102 of FIG. 1) and/or the generated text from the language model 208 as input. Various embodiments use this metric value model 214 as a score function to guide the language model 208. In some embodiments, the metric value model 214 evaluates the generated text based on specific engagement metrics, such as click-through rates (CTR), conversion rates, user satisfaction scores, or other metrics. The metric value model 214 provides a quantitative measure of how well the text meets the desired objectives or metrics. The metric value model 214 thus assesses the generated text sequences against specific engagement metrics. For instance, it might predict how likely the sequence “The quick brown fox jumps over the lazy dog” is to achieve a high click-through rate. The output of the metric value model 214 is a score or set of scores indicating the effectiveness of the text in terms of engagement or other metrics.

The energy-based model 216 is generally responsible for optimizing the generated text sequences to balance fluency (using anchor points from the language model 208) and engagement metrics (evaluated by the metric value model 214). It minimizes an energy function that incorporates both types of constraints. The energy-based model 216 includes a divergence component 218 and a weighted factor component 220.

The divergence component 218 is generally responsible for ensuring that the generated text from the language model 208 adheres to natural language patterns and maintains fluency (e.g., via KL divergence). The language model 208 provides reference distributions for each position in the text sequence. These reference distributions represent fluent and natural continuations of the text. The energy-based model 218 generates predicted distributions for the next word in the sequence based on the current context. In some embodiments, and as described in more detail below, the divergence component 218 calculates KL divergence between the predicted distribution and the reference distribution for each position in the sequence. This measures how much the predicted distribution deviates from the reference distribution. The KL divergence values are integrated into the energy function as a fluency constraint. The energy function aims to minimize these values, ensuring the generated text remains close to natural language patterns.

The weighted factor component 220 is generally responsible for controlling the magnitude of updates applied during the optimization process, ensuring efficient and targeted adjustments to the text embeddings. For example, and as described in more detail below, the weighted factor component 220 performs sparse weighting by Assigning lower gradients to most positions in the text sequence, focusing significant updates only on key positions. This selective updating helps in maintaining the overall structure and coherence of the text, leading to better natural language fluency. In some embodiments, and as described in more detail below, the weighted factor component 220 additionally applies a periodic weighted factor, which applies a systematic control over the updates at each position, preventing overfitting and ensuring stable optimization. This factor can vary periodically to modulate the update magnitude at different positions. Regarding integration into the optimization process, the weighted factors are applied to the gradients calculated during the optimization process, modulating the updates to the text embeddings.

In an illustrative example of how the language model 208, the metric value model 214, and the energy-based model 216 work together, the metric value model 214 first receives a dataset as input, such as text-metric pairs (e.g., email messages with open rates for opening the email messages) such that the metric value model predicts one or more metric scores with text as input. For example, for a particular block of text, some embodiments predict a click rate, which indicates how likely a user is to click on the text. Some embodiments then provide a language model (e.g., a Large Language Model) the metric value model as a scoring function and a text prompt as input such that the language model generates candidate text sequences. This means that the language model uses the metric scores predicted by the metric value model 214 to guide the text generation and optimization process. Each generated candidate sequence is passed through the metric value model 214, which evaluates and assigns a metric score based on predefined metrics (e.g., click-through rates, user satisfaction). For example, given the context “The quick brown fox,” the language model 208 predicts possible continuations like “jumps over the lazy dog” based on whether such continuations meet some metric score threshold. The language model 208 then performs a fluency check by providing reference distributions (anchor points) for the generated sequences to ensure they adhere to natural language patterns. The output of the language model 208 is the Supply of the necessary fluency constraints to be used in the optimization process. Some embodiments then convert the candidate text sequences generated by the language model to a text embedding (e.g., a vector representation).

The energy-based model 216 then generates updated text (or sends a signal to the language model 208 to regenerate text) by combining the engagement metric score from the metric value model 214 with the fluency constraints from the language model 208. For example, in some embodiments, the energy-based model 216 uses optimization techniques to iteratively update the text embeddings, minimizing the energy function and improving both engagement and fluency. In some embodiments, such functions adjust the generated text to reduce the KL divergence (fluency constraint) (via the divergence component 218) and maximize the engagement metric score. The output of system 200 is final text, which is an optimized text sequence that balances both natural language fluency and high engagement metrics, suitable for the intended application.

Consider the following example, the language model 208 first generates initial sequences and reference distributions. Initial sequence is “The quick brown fox jumps over the lazy dog.” The Anchor Points are as follows: {“jumps”: 0.7, “runs”: 0.2, “sleeps”: 0.05, “eats”: 0.05}. Metric Value Model 214 evaluates the sequence for engagement or other metrics. For example, the engagement score is indicative of a high likelihood of click-through (e.g., 0.8 on a scale of 0 to 1)

Regarding the optimization process, the energy-based model 216 defines the energy function incorporating both engagement scores and KL divergence. The energy-based model iteratively refines the sequence to optimize for both metrics to formulate the adjusted sequence: “The quick brown fox eagerly jumps over the lazy dog.” The final output is optimized text sequence: “The quick brown fox eagerly jumps over the lazy dog.” The characteristics are a high engagement score and adherence to natural language fluency. Accordingly, the language model 208 provides the initial text and fluency constraints, the metric value model 214 evaluates the engagement potential of the text, and the energy-based model 216 integrates these inputs to iteratively refine the text. This collaborative process ensures that the final output is both engaging and fluent, effectively meeting the desired objectives.

Storage 205 generally stores information including data (e.g., datasets (e.g., 102), generative text, computer instructions (for example, software program instructions, routines, or services), data structures, and/or models used in embodiments of the technologies described herein. In some embodiments, storage 205 represents any suitable data repository or device, such as a database, a data warehouse, RAM, cache, disk, RAID, and/or a storage network (e.g., Storage Area Network (SAN)).

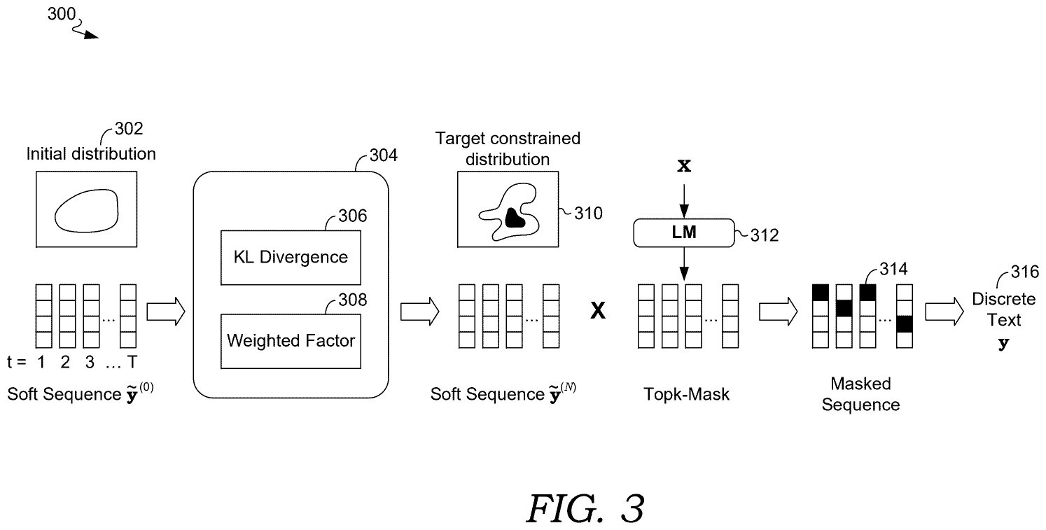

FIG. 3 is a block diagram of an example pipeline 300 for optimizing a set of metric constraints as a distribution over text, in the form of energy-based models (EBMs) to generate fluent and engaging text, according to some embodiments. In some embodiments, the pipeline 300 represents the functionality performed by the energy-based model 216 of FIG. 2. The pipeline 300 includes a first initialization step where a matrix 302 representing an initial distribution text embedding 302 is generated. The matrix 302 is provided as input to a function that performs energy-based sampling (e.g., via gradient-based optimization) via KL divergence 304 and a weighted factor 304. The output of the energy-based sampling 304 is a modified matrix 310, which represented a target constrained distribution or second text embedding that optimizes the particular conditions (e.g., has predicted high user engagement metrics, such as click rate). The modified matrix 310 is then multiplied by a top-k mask 312 to arrive at a masked sequence 314. The masked sequence 314 is then used to derive a final natural language output of generated text 316 (i.e., discrete text 316).

The initial distribution or soft sequence is a matrix 302 where each column represents a position in the tokenized sequence, and each entry in the column represents the probability of a specific token appearing at that position or timestamp. In some embodiments, such initial distribution represents the last layer of a transformer called the “logits.” The logits are the raw scores output by a final linear layer. They represent the model's unnormalized prediction scores for each possible token in the vocabulary. The matrix 302 indicates a probability of generating X token at y position or timestamp. Accordingly, each column in the matrix 302 can be thought of as a probability distribution over the vocabulary for that position. To create the initial distribution, various embodiments start with an initial context or prompt. This could be a few starting words or an empty sequence if generating from scratch. Various embodiments then use a pre-trained language model (e.g., language model 208) to generate the initial probability distributions for each position in the sequence. For example, if the context is “The quick brown,” the language model generates probabilities for the next word. The matrix 302 provides a flexible and probabilistic representation rather than fixed tokens. This flexibility allows the model to iteratively refine the sequence during the optimization process.

The language model initializes the soft sequence by producing a probability distribution for each token position. This distribution is represented in a soft sequence matrix where: rows correspond to vocabulary tokens. Columns correspond to positions in the sequence. For example, the context is “The quick brown.” Step 1: Tokenization: [“The”, “quick”, “brown”]. Step 2: Initial Probability Distribution: For each position, generate a probability distribution over possible next tokens: Position 1: [0.5 for “quick”, 0.2 for “slow”, 0.1 for “red”, 0.1 for “lazy”, 0.1 for “sleepy”]. Position 2: [0.6 for “brown”, 0.2 for “fox”, 0.1 for “dog”, 0.05 for “cat”, 0.05 for “rabbit”]. Position 3: [0.7 for “fox”, 0.1 for “dog”, 0.05 for “cat”, 0.05 for “bear”, 0.1 for “wolf”]

Various embodiments then responsively generate, for example, the soft Sequence matrix 302 with those values:

| “quick | “brown” | “fox” |
|---|---|---|
| 0.5 | 0.6 | 0.7 |
| 0.2 | 0.2 | 0.1 |
| 0.1 | 0.1 | 0.05 |
| 0.1 | 0.05 | 0.05 |
| 0.1 | 0.05 | 0.1 |

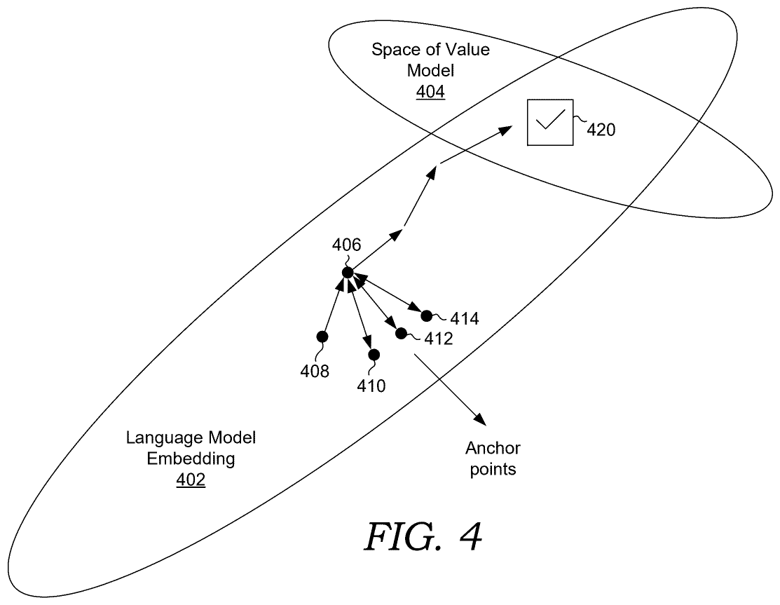

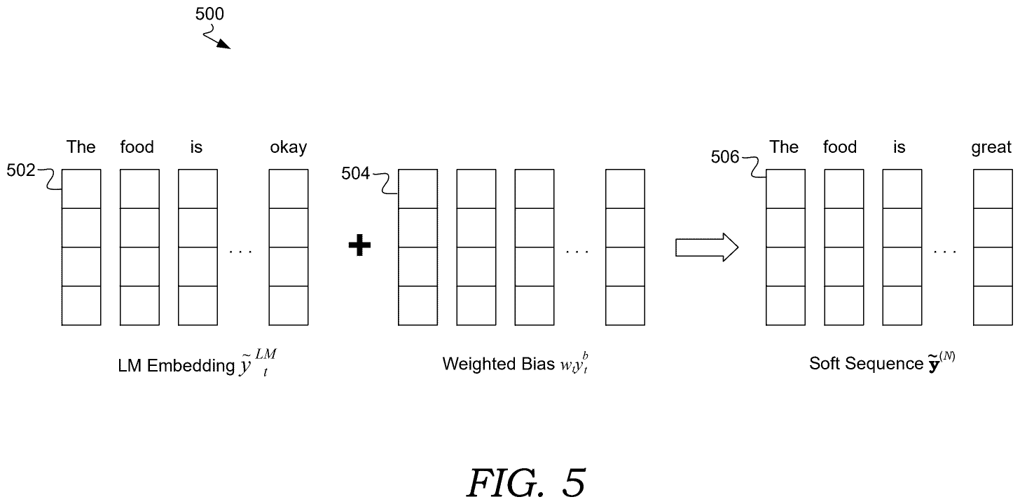

The energy-based model thus sets up the initial soft sequence matrix 302, where each column represents the probabilistic distribution of tokens for that position. The matrix 302 is provided to the energy-based sampling 304 as input so as to optimize the soft sequence. The energy-based sampling 304 and various equations are described in more detail below, such as in FIG. 4 and FIG. 5. The energy-based sampling 304 includes KL divergence 306 and weighted factor 308. In some embodiments, the KL divergence 306 represents the divergence component 218 of FIG. 2. In some embodiments, the weighted factor 308 represents the weighted factor component 220 of FIG. 2. The energy-based sampling 304 thus iteratively edits the generated text in its embedding space 302.

Energy-based sampling is a method used to generate samples from a probability distribution defined by an energy function. The energy function typically represents the “cost” or “unlikelihood” of a particular state, and the goal is to sample states with lower energy, which correspond to higher probability. This approach may be used in machine learning and statistical to find configurations that minimize the energy function. Energy-bases sampling thus samples from a complex, high-dimensional distribution by iteratively refining candidate samples to reduce their associated energy. The energy function is minimized using techniques such as gradient descent (and/or Langevin dynamics), where the samples are updated iteratively to move towards regions of lower energy (higher probability).

Langevin dynamics is typically used to iteratively update the soft sequence to minimize the energy function. However, various embodiments use KL divergence 306 and a weighted factor 308 are incorporated into the energy-based sampling process to achieve a similar goal of optimization through gradient-based methods. KL divergence 306 ensures that the generated text remains fluent by minimizing the divergence between the predicted distribution and the reference distribution (anchor points). KL divergence 306 is incorporated into the energy function as a fluency constraint.

The weighted factor 308 controls the magnitude of updates applied during the optimization process, ensuring efficient and targeted adjustments. For example, sparse weighting assigns lower gradients to most positions, focusing significant updates only on key positions.

During initialization, embodiments start with an initial soft sequence (i.e., the matrix 302), which is a probabilistic representation of the text. The energy function includes both engagement metrics and fluency constraints. Various embodiments compute the gradients of the energy function with respect to the soft sequence embeddings, as described in more detail below. Some embodiments also apply sparse weighting and periodic weighted factors to the gradients to control the magnitude of updates. Iterative updates (energy-bases sampling) is performed by updating the soft sequence iteratively to minimize the energy function, guided by the gradients and weighted factors. Refinement occurs by continuing the iterative updates until the energy function is minimized, resulting in an optimized soft sequence or matrix 310 that balances engagement and fluency. Energy-base sampling thus produces an optimized soft sequence represented by the matrix 310 that is converted into discrete text 316, ensuring both high engagement and natural language fluency.

The top-k mask 312 is applied to the target constrained distribution/matrix 310 to filter the most probable tokens. Top-k Mask is a technique used to retain only the top k highest probability tokens at each position in the sequence, setting the probabilities of all other tokens to zero. This ensures that only the most likely tokens, according to the model, are considered in the final sequence generation. At each position in the sequence of the matrix 310, the Top-k Mask 312 identifies the top k tokens with the highest probabilities in the target constrained distribution 310. For example, if k=3, the mask will retain only the top 3 highest probability tokens at each position.

The probabilities of tokens not in the top k are set to zero, effectively masking them out. This focuses the sequence generation on the most probable and relevant tokens, reducing noise and improving the quality of the generated text. The probabilities of the remaining top k tokens are, in some embodiments, re-normalized to sum to one, ensuring a valid probability distribution. The Top-k Mask is applied to the target constrained distribution 310 by multiplying the mask with the distribution matrix. This element-wise multiplication ensures that only the top k tokens are retained, and their probabilities are considered in the subsequent steps.

The masked sequence 314 is the result after applying the top-k mask 312 to the target constrained distribution 310. It represents the distribution with only the top k tokens retained and all other token probabilities set to zero. By applying the top-k mask 312 to the target constrained distribution 310, the process ensures that only the most probable tokens are considered for final text generation, improving the quality and relevance of the generated text at 316.

At the output, various embodiments generate discrete text 316 from the masked sequence 314 through a process of discretization that involves several steps. Discretization converts the masked sequence 314 into discrete text, selecting a single token for each position based on the probabilities. For each position in the masked sequence 314, some embodiments select the token with the highest probability. This selection converts the probabilistic representation into a deterministic sequence of tokens. The language model (LM) can be used to assist in the selection process, ensuring that the final sequence is coherent and contextually appropriate. Regarding top-k selection, the model can use techniques like beam search or greedy decoding to select the most probable tokens. Regarding final sequence assembly, various embodiments then assemble the selected tokens into the final discrete text sequence. This sequence represents the model's output text.

FIG. 4 is a schematic diagram illustrating how multiple anchor points are used for batched KL Divergence, according to some embodiments. In some embodiments, the functionality as described below with respect to FIG. 4 is performed by the divergence component 218 of FIG. 2 and/or KL divergence 306 of FIG. 3. FIG. 4 illustrates that a batch of anchor points 406, 408, 410, 412, and 414 are used, instead of a single anchor point. Constraining to a single anchor point is biased. More anchor points better represents the language model embedding 402. Moreover, FIG. 4 illustrates generating representations of text 420 that not only fall within the language model embedding 402, but also within the space of the value model 404 (e.g., the metric value model 214).

Batched KL divergence is a way to regularize the optimization process. It adds a constraint (e.g., optimize for high click rates). Given a batch of generated text, after each iteration, the revised text embedding is still ideally close to at least some of the anchor points 406, 408, 410, 412, or 414 in the language mode embedding 402. KL divergence is a way to measure whether two embeddings are close to each other to make sure points keep falling in the language model embedding 402 or space during optimization. Accordingly, various embodiments are trying to constrain the predicted/generated text (a points) to be close to the anchor points 406, 408, 410, 412, and 414. An anchor point is text (e.g., a sentence) generated from a language model.

Below is a description of how KL divergence with respect to FIG. 4 functions mathematically, according to some embodiments. In some embodiments, mathematical equations (4) through (6) below are performed by the divergence component 218 of FIG. 2. Various embodiments focus on controllable text generation in the decoding time or phase. Energy-based models are useful for their flexibility and general modeling capability to incorporate any constraints. After preliminary experiments on existing technologies, one issue was discovered that was not fully addressed in previous work-after several iterations of sampling, the quality of the generated text degrades considerably. Specifically, the inventors have observed that the subsequent text becomes less fluent, grammatically incorrect, or even non-human-readable.

Various embodiments are built upon the existing concept of controllable text generation via Energy-Based Models (EBMs): Given a language model, embodiments generate text y from the language model that satisfies some constraints, where each constraint can be captured by a function ƒᵢ(y)∈R and higher value of ƒᵢ(y) means the text better matches the constraint. For example, if users desire to control the sentiment (or other metric) of generated text, higher ƒᵢ(y) could represent more positive sentiment. The set of constraints induces a distribution over the text, which can be written in an energy-based form as follows:

$$p ( y ) = exp \{ {\sum }_{i} {λ}_{i} {f}_{i} ( y ) \} / Z \qquad ( 1 )$$

where λᵢ≥0 is the weight for the i-th constraint, Z is a normalization factor, and the energy function is E(y)=−Σᵢλᵢƒᵢ(y). In this formulation, generating text under the constraints can be viewed as sampling from the energy based distribution y˜p(y).

The energy function is defined on a “soft sequence”, i.e., a sequence of continuous vectors-\tilde{y}=\tilde{y}₁, . . . , \tilde{y}ᵣ with T being the sequence length. For example, \tilde{y} could be the logits of the language model. Starting from an initial point, the sequence can be updated with gradient descent:

$${\tilde{y}}^{n + 1} ← {\tilde{y}}^{n} - η {∇}_{\tilde{y}} E ( {\tilde{y}}^{n} ) + {ϵ}^{n} \qquad ( 2 )$$

To enable sampling such that diverse text from the low energy area can be generated, Langevin dynamics is used with some existing technologies:

$${\tilde{y}}^{n + 1} ← {\tilde{y}}^{n} - η {∇}_{\tilde{y}} E ( {\tilde{y}}^{n} ) + {ϵ}^{n} \qquad ( 3 )$$

For controlling of attributes (e.g., sentiment, toxicity), attribute classifiers are often used as constraints, e.g., ƒᵢ(y)=p_{⊖}(c|(y)), where p_{⊖}(c|(y)) is the probability of the sequence y with the attribute c, predicted by the attribute classifier ⊖.

Though the aforementioned formulation provides a solution to generate text under constraints, in practice, it has been found that there is a major issue with the generation quality that it is challenging to maintain the fluency of the text when updating the soft sequence with Eq. (3). As the text embeddings generated by language models are sparse structures in a high-dimensional space (i.e., a manifold), updating embeddings in the latent space will often result in text that is not human readable. In other words, the embedding no longer lies in the space (e.g., the language model embedding 402) of the language model after several iterations. In some embodiments, components, such as the divergence component 218 and/or the weighted factor component 220 are used to mitigate this problem.

To encourage the generated text to be fluent, a fluent constraint is introduced as:

$${f}_{fluent} ( \tilde{y} ) = - {\sum }_{t = 1}^{T} {\sum }_{v ∈ V} P L M ( v \vert {\tilde{y}}_{< t} ) log ( {\tilde{y}}_{< t} ) \qquad ( 4 )$$

where PLM(·|\tilde{y}_{<t}) is the next-token distribution when providing the neural language model with the preceding soft tokens −\tilde{y}_{<t}. This cross-entropy loss is equivalent to KL divergence:

$${f}_{fluent} ( \tilde{y} ) = {\sum }_{t = 1}^{T} K L ( P L M ( v \vert {\tilde{y}}_{< t} ) \vert \vert {\tilde{y}}_{< t} ) \qquad ( 5 )$$

Intuitively, using a single anchor point to represent the manifold of a language model is not enough. To alleviate the problem, various embodiments use a batched KL divergence. Instead of using a single point as a constraint, various embodiments leverage all points in the mini-batch as anchor points (e.g., anchor points 406, 408, 410, 412, and 414), and minimize the distance between the updated embedding and these anchor points:

$${f}_{fluent} ( \tilde{y} ) = \frac{1}{N} {\sum }_{i = 1}^{N} {\sum }_{t = 1}^{T} K L ( P L M ( v \vert {\tilde{y}}_{< t}^{[ i ]} ) \vert \vert {\tilde{y}}_{< t}^{[ i ]} ) \qquad ( 6 )$$

where \tilde{y}^{[i]} is the i-th embedding in a mini-batch of size N. Empirically, the anchor points provide a more robust distance measure to encourage the updated embeddings to stay close to the space of the language model (e.g., the language model embedding 402) while at the same ensuring these updated embeddings stay within the space of the value model 404.

FIG. 5 represents a pipeline 500 illustrating altering only a few key words of the language model output via a sparse weighting function, according to some embodiments. In some embodiments, the pipeline 500 represents the functionality of the weighted factor component 220 of FIG. 2. The pipeline 500 includes an initial distribution or input matrix 502, which is added with the weighted matrix 504 to derive the output matrix 506, representing a soft sequence. In some embodiments, the input matrix 502 represents the initial matrix 302 of FIG. 3 (and/or the matrix 310). As illustrated in the matrix 502, each column is a distribution of tokens “the” “food” “is” “okay,” where each column corresponds to each token. However, the inventors have observed that no all columns of the matrix 502 need to be changed. With existing technologies, every time optimization occurs to a second matrix, these technologies change the entire matrix by changing each column of the matrix. However, various embodiments just change a few columns in the matrix 500. The more that changes are made, the harder it is to ensure that a point or natural language sequence falls within language model space (e.g., the language model embedding 402).

The weighted matrix 504 controls which column corresponding to a word is to be changed. For every column, various embodiments specify the degree of change needed. Based on this change, the output matrix 506 is generated. As indicated in FIG. 5, only one word is changed from the input matrix 502 to the output matrix 506-“the food is okay” to “the food is great,” where only the word “okay” is changed to “great.”

Various embodiments thus implement a Sparse Weighted Function to generate the weighted matrix 504. With existing technologies, it is still difficult to make sure the updated embedding lies in the manifold (e.g., the language model embedding 402) of the language model after several iterations, since it may not be possible to obtain an analytical form of the manifold of a language model, and gradient descent with Langevin dynamics will always introduce noise. Another intuitive solution to further mitigate this problem is simply to update less. Motivated by the observation that altering a few keywords can significantly change the semantics of a sentence, some embodiments (e.g., the weighted factor component 220) use a sparse weighting function to assign lower gradients to most positions, and encourage the model to mainly update only a few words in a sequence at each time step or position.

At each decoding step t, instead of updating \tilde{y}ₜ directly, some embodiments add the tunable bias yₜ⁻¹∈ [symbol] to the PLM predicted logits \tilde{y}ₜ as follows:

$${\tilde{y}}_{t} = {\tilde{y}}_{t} + {w}_{t} \cdot {y}_{t}^{- b} \qquad ( 7 )$$

To encourage the model to update only a few positions, some embodiments leverage a periodic weighting factor

$${w}_{t} = sin ( 2 n k \cdot \frac{t}{L} )$$

to introduce sparsity into the updating process and control the contributions of each token. The period is

$$\frac{L}{k}$$

where k is a hyperparameter that controls how many tokens are assigned with the largest changes per gradient update. In this way, embodiments control the gradients and ensure that some positions in the sequence are updated more or less than others.

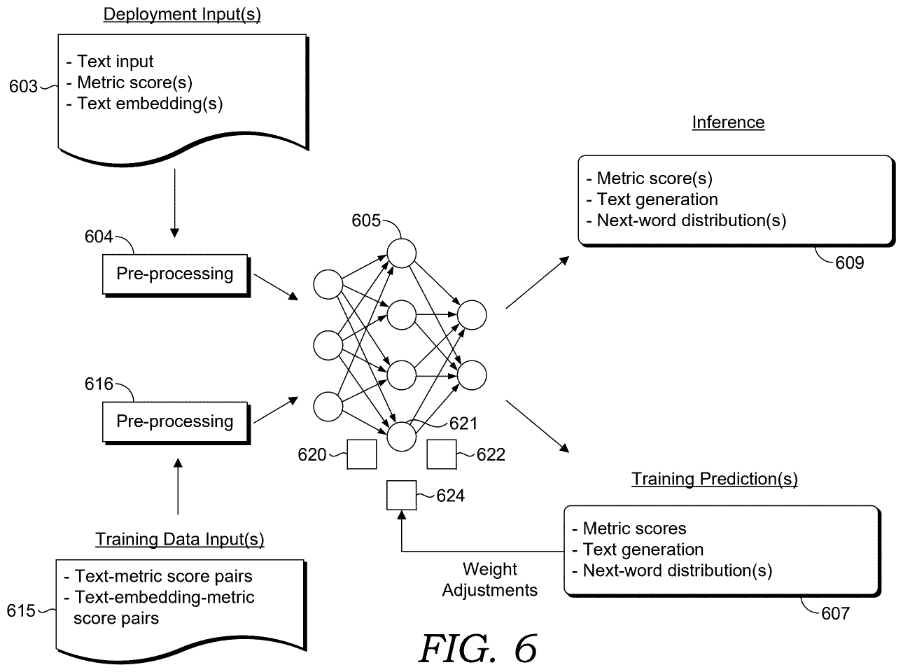

FIG. 6 depicts a diagram of an example neural network 605 that is trained to generate one or more metric scores, text, and/or next word distributions, according to some embodiments. In some embodiments, the neural network 605 represents the metric value model 214, the language model 208, or the energy-based model 216 of FIG. 2. In some embodiments, the neural network 605 represents any suitable model functionality, such as supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, a linear discriminate analysis, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial lest squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or any suitable form of machine learning algorithm.

The neural network 605 is modeled as a data flow graph (DFG), where each node (e.g., 621) in the DFG is an operator with an input and output tensor, such as 620 and 622. A “tensor” (e.g., a vector) is a data structure that contains values representing the input, output, and/or transformations processed by the operator. Each edge of the DFG depicts the dependency between the operators. Neural network 605 includes an input layer, an output layer and one or more hidden layers. An Input layer is the first layer of the neural network 605. The input layer receives pre-processed (e.g., via the pre-processing 604 or 616) input data represented by 603 and 615. The Output layer (e.g., a classification layer) is the last layer of neural network 605. The output layer generates the predictions, which is represented by the inference and predictions 609 and 607. Neural network 605 may include any number of hidden layers. Hidden layers are intermediate layers in neural network 605 that perform various operations.

Each node in FIG. 6, such as node 621, is associated with or includes an activation tensor, such as input tensor 620, output tensor 622, and/or intermediate tensors. An “activation tensor” is a tensor that is an input, intermediate, and/or output to at least one neural network layer (e.g., as modeled going from left to right), as illustrated by the flow of data from input tensor 620 to output tensor 622. This is different than a weight tensor, such as 624, where weight tensors are modeled as flowing upward (not being actual inputs or outputs). In other words activation tensors represent some form of the neural network inputs 603 and 615. For example, the input tensor 620 or node 621 can represent specific data points, such as the presence or absence or words in a vocabulary, whereas a weight tensor represents the weight values indicating node activation/inhibition values indicating significance of the particular data point for the overall prediction at 609 or 607. In some embodiments, the input tensor 620 (or any other input tensor) represents the initial or any other text embeddings, as described herein, such as text embedding or initial distribution 302.

Each node in the network 605 may also be associated with or include and/or a weight tensor (e.g., 624), which include weight values. A “weight” in the context of machine learning may represent the importance or significance of a feature or feature value for prediction. For example, each feature (e.g., particular columns or words in a matrix or metric) may be associated with an integer or other real number where the higher the real number, the more significant the feature is for its prediction. In some aspects, a weight in a neural network represents the strength of a connection between nodes or neurons from one layer (an input) to the next layer (a hidden or output layer). A weight of 0 may mean that the input (e.g., the input tensor 620) will not change the output (e.g., the output tensor 622), whereas a weight higher than 0 changes the output. The higher the value of the input or the closer the value is to 1, the more the output will change or increase. Likewise, there can be negative weights. Negative weights may proportionately reduce the value of the output. For instance, the more the value of the input increases, the more the value of the output decreases. Negative weights may contribute to negative scores. For example, a particular sentence may be highly correlated with a specific metric score and so neural network layers or nodes representing the sentence may be weighted higher so that that this data is activated or taken into account when making a final prediction score.

Each node of the neural network 605 may additionally perform a function using the activation tensors and weight tensors, such as activation functions, matrix multiplication, normalization, or the like. In some examples, the nodes in the neural network 605 are fully connected or partially connected. Continuing with FIG. 6, each node may process an input in 603 and 615 (or portion thereof) using activation tensors and weight tensors. In some examples, in response to receiving the deployment input(s) 603 and the training data input(s) 315, the neural network 605 first performs pre-processing 604 or 616, such as encoding or converting such input into machine-readable indicia representing the entire input (e.g., a tensor representing all of the deployment input(s) 603). Responsively, the node may then receive an input tensor, which may, for example, represent whether a feature (e.g., a specific word or metric) are present in the input. In some examples, the input tensor is an N-dimensional tensor, where N can be greater than or equal to one. In some examples, an input tensor 620 represents the input data of neural network 605 if the node is in the input layer. In some examples, the input tensor 620 is also the output of another node in the preceding layer. In some examples after a node, such as the node 621, performs an operation using the input tensor 620, it generates an output tensor 622, which is then passed to the other neurons in the hidden layer and/or output layer. The output tensor 622 represents the output processed by the node 621. For example, the output tensor 622 may be a matrix representing the product of matrix multiplication or a matrix indicating whether words were present. In various aspects, the output tensor 622 represents an input of another node in the succeeding layer (i.e., the output layer).

In some examples, node 621 applies a weight tensor 624 to the input tensor 620 via a linear operation (e.g., matrix multiplication, addition, scaling, biasing, or convolution). All other nodes in the neural network may perform identical functionality. In some examples, the result of the linear operation is processed by a non-linear activation, such as a step function, a sigmoid function, a hyperbolic tangent function (tan h), and rectified linear unit functions (ReLU) or the like. The result of the activation or other operation is an output tensor 622 that is sent to a subsequent connected node that is in the next layer of neural network 605. The subsequent node uses the output tensor 622 as the input activation tensor to another node.

Each of the functions in the neural network 605 may be associated with different coefficients (e.g., weights and kernel coefficients) that are adjustable during training. For example, after preprocessing 616 (e.g., normalization, feature scaling and extraction) in various aspects, the neural network 605 is trained using a data set of the preprocessed training data inputs 615 in order to make acceptable loss training predictions at the appropriate weights to set the weight tensors. This will help later at deployment time to make a correct inference 609. In some aspects, learning or training includes minimizing a loss function between the target variable (for example, a correct metric score prediction) and the actual predicted variable (for example, an incorrect metric score prediction). Based on the loss determined by a loss function (for example, Mean Squared Error Loss (MSEL), cross-entropy loss, etc.), the loss function learns to reduce the error in prediction over multiple epochs or training sessions so that the neural network 605 learns which features and weights are indicative of the correct inferences, given the inputs. Accordingly, it is desirable to arrive as close to 100% confidence in a particular classification or inference as much as possible so as to reduce the prediction error.

Subsequent to a first round/epoch of training, the neural network 605 makes predictions with a particular weight value, which may or may not be at acceptable loss function levels. For example, the neural network 605 may process the pre-processed additional training data inputs 615 a second time to make another pass of predictions. This process may then be repeated over multiple iterations or epochs until the weight values in the weight tensors are learned for optimal predicted values and/or the loss function reduces the error in prediction to acceptable levels of confidence.

Continuing with FIG. 6, in some examples, the neural network 605 is trained in a supervised manner using annotations or labels. For example, in some examples, training includes (or is preceded by) annotating/labeling training data 615 so that the neural network 605 learns associations between the features or weights and corresponding labels, which is used to change the weights/neural node connections for future predictions. For example, different pieces of text (e.g., emails, ads, chats, item listings) can be labeled with real metric scores (e.g., click rate=50). In this way, the metric value model 214 can be trained to predict the metric score(s) in 607 using the text from the text-metric score pairs as input. In another example, the language model 208 (e.g., a LLM) may include text as input to perform the text generation predictions in 607 using techniques like Next Sentence Prediction (NSP) or Masked Language Modeling (MLM).

Additionally or alternatively, the energy-based model 216 may be trained using the text embedding from the text-embedding-metric score pairs from 615 as input to predict the next word distribution(s) in 607. In this way, the neural network 605 can learn which weights or features are indicative of a specific next word distribution given a column(s) of a text embedding. As such, the neural network 605 accordingly adjusts the weights (the weight tensors) or deactivates nodes such that certain nodes corresponding particular words, sentences, and/or metrics are activated and other nodes corresponding to other words, sentence, and/or metrics are inhibited to make predictions.

Subsequent to the neural network 605 training, the neural network 605 (for example, in a deployed state) receives the pre-processed deployment input(s) 603. When a machine learning model is deployed, it has been trained, tested, and packaged so that it can process data it has never processed. Responsively, in some aspects, the deployment input(s) 603 (i.e., text input, metric scores, and/or text embeddings) are fed to the neural network 605, which then uses the same weight tensors (e.g., 624) that were learned via training so that the neural network 605 can produce the correct inference predictions 609. For example, the input tensor 620 can include new values (e.g., words corresponding to new data) which is then multiplied or otherwise combined with the weight tensor 624, representing the same weight values learned at training, in order to make the inference prediction(s) 609.

In some embodiments, the text input and metric score(s) in the deployment input(s) 603 represent the dataset 102 of FIG. 1, which is used by the metric value model 214 to predict the metric score(s) at inference time in 609. In some embodiments, the text input in the input(s) 603 represents input fed to the language model 208 so that the language model 208 performs the text generation at inference time in 609. In some embodiments, the text embedding(s) in the deployment input(s) 603 represent the output of the language model 208 (i.e., the “text generation” at in 609), which is then used by the energy-based model 216 to predict the next word distribution(s) at inference time in 609.

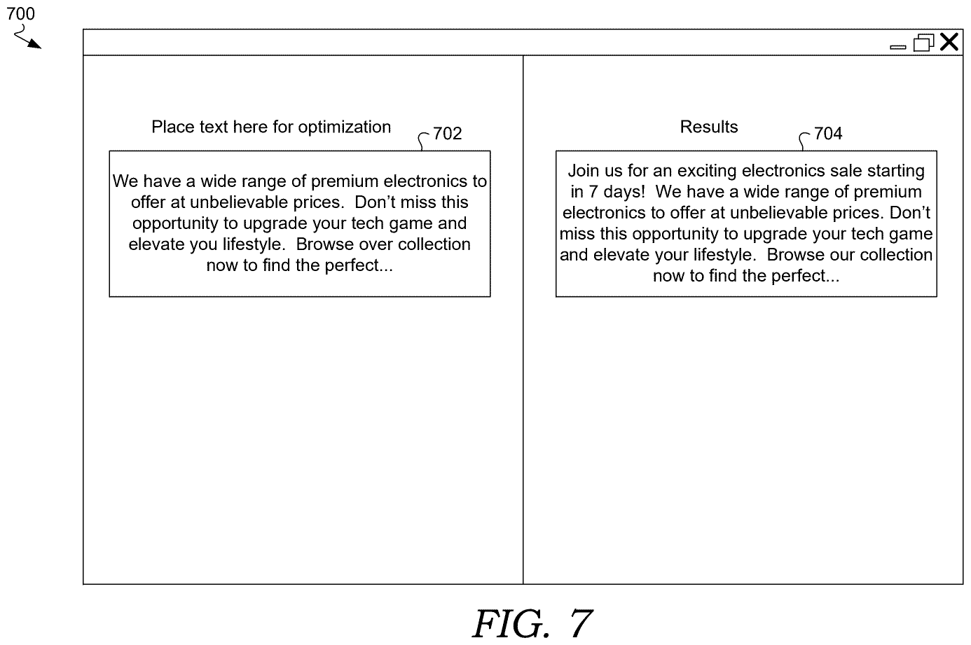

FIG. 7 is a screenshot of an example page 700 of a user interface for generating optimized text, according to some embodiments. At a first time, embodiments first receive input text 702. Text 702 may represent an ad or email that a marketer desires to be optimized before it is deployed in an email or other channel. In some embodiments, in response to receiving the text 702, the metric value model 214 first performs its functionality to predict one or more metric scores, such as a predicted click rate, open rate, sentiment, etc. This metric be used as a score function and provided, along with the text 702, to the language model 208 so that the language model 208 generates a first generates output text. Such first output text may then be provided to the energy-based model 216 as input, which responsively causes the output text 704 to be generated. In training, for example, training emails are labeled with a set of rules: for a given email, the earlier that discounts or sales are mentioned in the email, the higher the metric score it will receive. This is to mimic user preference that some users may prefer to click or view promotion links when there is a sell-off. Various embodiments capture this user preference and generate such emails with higher scores. As illustrated in the output text 704, for example, the first sentence mention sales according to the training rules, whereas the original input text 702 does not contain such sales language and sentence. All of the other sentence and language remain the same. Accordingly, various embodiments change the text embeddings as described herein to both generate fluent natural language and meet particular metrics.

### Example Flow Diagrams

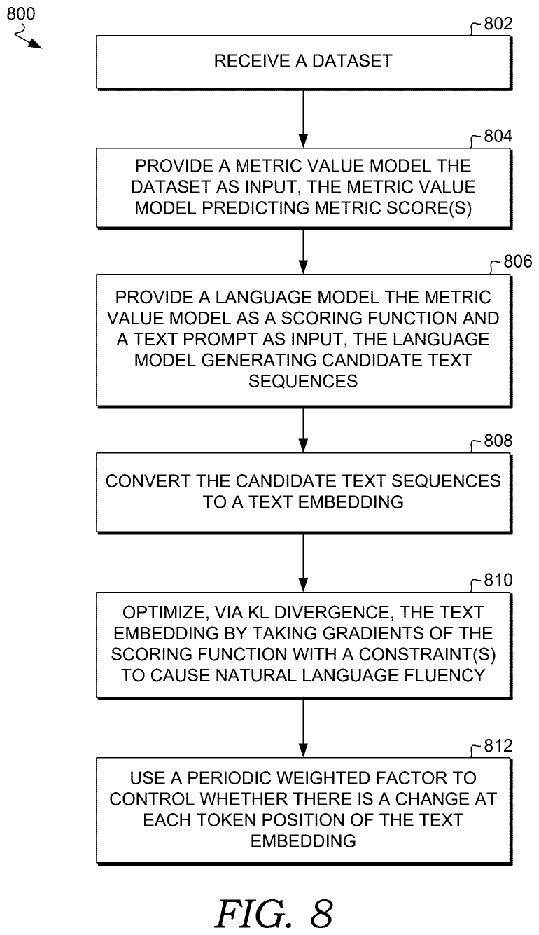

FIG. 8 is a flow diagram of an example process 800 for optimizing a text embedding of a language model, according to some embodiments. The process 800 (and/or any of the functionality described herein, such as process 900) may be performed by processing logic that comprises hardware (e.g., circuitry, dedicated logic, programmable logic, microcode, etc.), software (e.g., instructions run on a processor to perform hardware simulation), firmware, or a combination thereof. Although particular blocks described in this disclosure are referenced in a particular order at a particular quantity, it is understood that any block may occur substantially parallel with or before or after any other block. Further, more (or fewer) blocks may exist than illustrated. Added blocks may include blocks that embody any functionality described herein (e.g., as described with respect to FIG. 1 through FIG. 11\2). The computer-implemented method, the system (that includes at least one computing device having at least one processor and at least one computer readable storage medium), and/or the computer readable medium as described herein may perform or be caused to perform the process 800 or any other functionality described herein.

Per block 802, some embodiments receive a dataset. In some embodiments, the dataset represents text-metric pairs, as illustrated by the dataset 102 of FIG. 1. In some embodiments, the dataset alternatively represents any initial set of text provided by a user, such as the initial text 702 of FIG. 7. In some embodiments, the dataset represents any language model generated text output.

Per block 804, some embodiments then provide a metric value model the dataset as input such that the metric value model predicts one or more metric scores based on having trained on text-metric score pairs as described, for example, with respect to the neural network 605 of FIG. 6. Per block 806, some embodiments then provide a language model the metric value model as a scoring function and a text prompt as input such that the language model generates candidate text sequences. A “text prompt” as described herein in the context of language models refers to the initial input or query provided to the model to elicit a response. This input can be in the form of a question, a statement, a command, a set of instructions, or any other form of text that guides the model on what kind of response is expected. The prompt sets the context and direction for the language model, influencing how it generates its subsequent output. In some embodiments, the text prompt includes one or more one-shot or two shot example, that give the model indicators, such as example input-output pairs to guide the models for generating a response.

In some embodiments, the candidate text sequences in block 806 are generated based on techniques such as reinforcement learning, which can be used where the model is trained to maximize the expected engagement score. The engagement score acts as the reward signal in reinforcement learning. During training, the model updates its parameters to increase the likelihood of generating high-scoring sequences.

Block 806 effectively means that the language model uses the metric scores predicted by the value model to guide the generation and optimization process. For example, language model begins be receiving an initial prompt or context (e.g., “The quick brown fox”). The language model then generates multiple candidate continuations/natural language sequences for the given context. This can be done using techniques like beam search, where several sequences are generated in parallel. Each generated candidate sequence is passed through the metric value model, which evaluates and assigns a metric score based on predefined metrics (e.g., click-through rates, user satisfaction). The value model produces a score for each candidate sequence, indicating its expected performance in terms of engagement or metrics. The generated sequences are ranked based on their metric scores. The higher the score, the more likely the sequence is to meet the desired metric criteria. The top-ranked sequences are selected as the final output. This can be the single highest-scoring sequence or a set of top sequences for further processing. In an illustrative example, the initial candidate text sequences (given the prompt “The quick brown fox”) may be “jumps over the lazy dog,” “runs swiftly through the forest,” and “sleeps under the tree.” The value model that scores each of these sequences: “jumps over the lazy dog.”->Score: 0.8, “runs swiftly through the forest.”->Score: 0.6, “sleeps under the tree.”->Score: 0.4. Ranking may include: 1st: “jumps over the lazy dog.” (Score: 0.8); 2nd: “runs swiftly through the forest.” (Score: 0.6); 3rd: “sleeps under the tree.” (Score: 0.4). The selected sequence (i.e., the candidate text sequences) is then “jumps over the lazy dog.” Based on being the highest score.

Per block 808, various embodiments then convert the candidate text sequences generated by the language model to a text embedding, as described, for example, with respect to the embedding generator 204 of FIG. 2. Per block 808, various embodiments then optimize, via KL divergence, the text embedding by taking gradients of the score function with one or more constraints to cause natural language fluency, as described, for example, with respect to FIG. 4. Per block 812, various embodiments then use a periodic weighted factor to control whether there is a change at each token position of the text embedding. For example, various embodiments, such as the weighted factor component 220, then changes one or more columns in an output matrix as described, for example, with respect to FIG. 5.

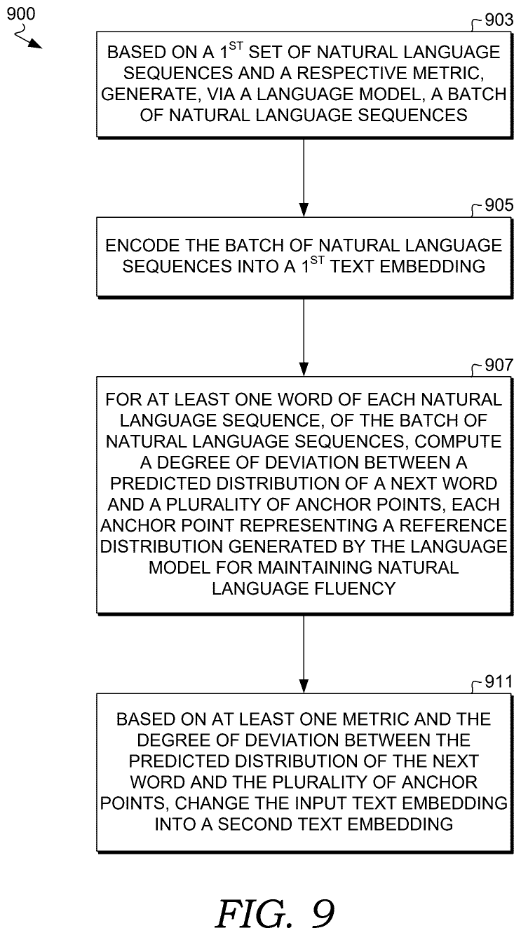

FIG. 9 is a flow diagram of an example process 900 for changing or optimizing a set of text based on a divergence measure, according to some embodiments. Per block 905, some embodiments encode a batch of natural language sequences into a first text embedding (e.g., as described with respect to the embedding generator 204). In some embodiments, the batch of natural language sequences block 905 represent a dataset, such as the dataset 102 input by a user. In other embodiments, the batch of natural language sequences represent a response output generated by a language model. In these language model embodiments, based on a first set of natural language sequences (e.g., the dataset 102) and a respective metric, some embodiments generate, via a language model, a batch of natural language sequences (e.g., a batch of sentences). Examples of this are described per step block 806 of FIG. 8, where the candidate text sequences represent or are the same as the batch of natural language sentences. For example, some embodiments first access a dataset (e.g., the dataset 102) that includes the first set of natural language sequences and a respective metric associated with each natural language sequence, of the first set of natural language sequences. And based on the first set of natural language characters and the respective metric associated with each natural language sequence, some embodiments generate, via a language model, a batch of natural language sequences.

In some embodiments, the respective metric associated with each natural language sequence (or any other metric and/or metric value described herein) includes at least one of: a sentiment value, an attractiveness value, a popularity value, a quantity of clicks, a click-through rate (CTR), a conversion rate, an open rate, engagement time, a bounce rate, social media shares and likes, an email response rate, a form completion rate, and a user feedback and rating. A sentiment value is a numerical representation of the sentiment expressed in a piece of text, typically ranging from negative to positive. For example, a sentiment score of −1 might indicate very negative sentiment, 0 neutral, and +1 very positive. An attractiveness value is a measure of how visually appealing or engaging content is perceived to be by users. For example, a high attractiveness score might indicate that the content has appealing visuals, layout, and design. A popularity value is a measure of how widely liked or accepted a piece of content is among its audience. For example, popularity can be assessed through metrics such as views, shares, and likes.

A quantity of clicks refer to the total number of times users have clicked on a particular link or element within a piece of content. For example, if a webpage link is clicked 500 times, its quantity of clicks is 500. The click-through rate (CTR) refers to the percentage of users who click on a specific link out of the total users who view the page, email, or advertisement. For example, if 1000 people view an ad and 50 click on it, the CTR is 5% (50/1000*100). A conversion rate refers to the percentage of users who complete a desired action (e.g., making a purchase, signing up for a newsletter) out of the total users who interact with the content. For example, if 2000 users visit a website and 40 make a purchase, the conversion rate is 2% (40/2000*100). An open rate refers to the percentage of recipients who open a specific email out of the total number of emails sent. For example, if an email campaign is sent to 5000 recipients and 1000 open the email, the open rate is 20% (1000/5000*100). Engagement time refers to the amount of time users spend interacting with a piece of content. For example, if the average user spends 3 minutes reading an article, the engagement time is 3 minutes. Bounce rate is the percentage of visitors who navigate away from a site after viewing only one page. For example, if 100 users visit a site and 60 leave without interacting further, the bounce rate is 60% (60/100*100).

Social media shares and likes refers to the number of times a piece of content is shared and liked on social media platforms. Email response rate is the percentage of recipients who respond to a specific email out of the total number of emails sent. For example, if 1000 emails are sent and 50 recipients respond, the email response rate is 5% (50/1000*100). Form completion rate refers to the percentage of users who complete a form out of the total users who started filling out the form. For example, if 300 users start filling out a registration form and 150 complete it, the form completion rate is 50% (150/300*100). User feedback and rating describes the qualitative and quantitative evaluations provided by users regarding their experience with a product, service, or content. For example, a mobile app might have an average rating of 4.5 stars based on user reviews.

In these embodiments, the generating of the batch of natural language sequences is based on computing, via a value model, a metric score for each natural language sequence of the batch of natural language sequences. The metric score being indicative of how well a respective natural language sequence of the batch of natural language sequences is expected to perform according to a given metric. In some embodiments, a “metric score” refers to a predicted metric value itself as described above, such as a prediction of an actual click rate for a given set of text. Alternatively, in some embodiments the metric score is a score directly proportional to the ranking or rating of a particular text candidate that corresponds to the predicted metric value. For instance, if the predicted click rate is 0.56 (the highest predicted click rate among all candidates) the metric score may be 1, which represents the highest ranked piece of text based on the predicted click rate.

Per block 907, for at least one word of each natural language sequence of the batch of natural language sequences some embodiments compute a degree of deviation between a predicted distribution of a next word and a plurality of anchor points. Each anchor point representing a reference distribution generated by the language model for maintaining natural language fluency. Examples of block 907 are described with respect to the divergence component of FIG. 2, equations (4) through (6) of FIG. 4, and KL divergence 304 of FIG. 3. For example, batch might include sentences like “The quick brown fox,” “jumps over the lazy dog,” and “and runs away.” The predicted distribution of a next work refers to the probability distribution over the vocabulary for the next word in a sequence, predicted by the language model based on the current context. For example, given the sequence “The quick brown,” the model might predict the next word with probabilities: {“fox”: 0.7, “dog”: 0.2, “cat”: 0.1}. Anchor points are reference distributions representing fluent continuations, generated by the language model. For example, for the context “The quick brown,” the anchor points might include {“fox”: 0.6, “dog”: 0.3, “cat”: 0.1} and other variations. The degree of deviation refers to a measure of how much the predicted distribution differs from the reference (anchor point) distributions. For example, the degree of deviation may refer to the difference between the predicted distribution {“fox”: 0.7, “dog”: 0.2, “cat”: 0.1} and an anchor point {“fox”: 0.6, “dog”: 0.3, “cat”: 0.1}. The degree of deviation (KL divergence) may be used as part of the loss function to adjust the model's parameters, encouraging it to generate more fluent text.

In some embodiments, the computing of the degree of deviation between the predicted distribution of the next word and the plurality of anchor points at block 907 is based on computing batched Kullback-Leibler (KL) Divergence, and the degree of deviation is computed using KL divergence for each context t and each natural language sequence i in the batch, where the batched KL divergence is an average or sum of the KL divergences across all of the natural language sequences and positions in the batch of natural language sequences. For example, the batch of sequences may be: [“The quick brown fox”, “jumps over the lazy dog”, “and runs away quickly”]. For each sequence in the batch, and for each position within each sequence, the model predicts the next word distribution. For example, regarding “The quick brown,” position t=4 (next word after “The quick brown”), the predicted distribution is P(predicted|“The quick brown”)= {“fox”: 0.7, “dog”: 0.2, “cat”: 0.1}. For the same position and context, embodiments generate reference distributions (anchor points) from a pre-trained language model. For each anchor point, some embodiments compute the KL divergence between the predicted distribution and each anchor point. For example, for anchor point 1:

$$K L ( {P}_{p redicted} \vert \vert {P}_{anchor 1} ) = 0.7 log \frac{0.7}{0.6} + 0.2 log \frac{0.2}{0.3} + 0.1 log \frac{0.1}{0.1}$$

Some embodiments then sum or average the KL divergence values across all sequences and positions in the batch. For example, assume the batch contains 3 sequences, and each sequence has 5 positions (excluding the last token) via batched KL divergence:

$$Batched KL Divergence = \frac{1}{N} {\sum }_{i = 1}^{N} {\sum }_{t = 1}^{T} K L ( {P}_{predicted} ( v \vert {context}_{t}^{i} \vert \vert {P}_{reference} ( v \vert {context}_{t}^{i} ) )$$

where N is the number of sequences and T is the number of positions in each sequence. Accordingly, batched KL divergence describes a process where the model computes the degree of deviation between its predicted distribution for the next word and multiple anchor points (reference distributions) using batched KL divergence. This is done for each position t in each sequence i in a batch, and the batched KL divergence is obtained by averaging or summing the KL divergences across all sequences and positions. This approach ensures that the model maintains natural language fluency while generating text.

Per block 911, based on at least one metric and the degree of deviation between the predicted distribution of the next work and the plurality of anchor points, some embodiments change the input text embedding (e.g., the first matrix 302) into a second text embedding (e.g., the second matrix 310). In some embodiments, such change is based on assigning a low gradient to most positions in the first text embedding and introducing a periodic weighted factor that controls the change at each position of the first text embedding when generating the second text embedding. Examples of this are described with respect to FIG. 5, the weighted factor component 220 of FIG. 2, and the weighted factor 308 of FIG. 3. Gradients are essentially the directions and magnitudes of changes that need to be applied to the embeddings during the optimization process. By assigning low gradients, the model ensures that only minimal changes are made to most positions. This approach helps preserve the overall structure and semantics of the initial text, making the generation process more stable and preventing overfitting to specific parts of the data. The periodic weighted factor is introduced to modulate the gradient values at different positions. This factor can vary periodically (e.g., following a sinusoidal pattern) and is applied across the sequence of embeddings. This weighted factor helps in focusing the updates on certain positions more than others in a periodic fashion, allowing the model to make more significant changes where necessary while maintaining stability in other parts. This controlled approach ensures that the generated text maintains fluency and coherence.

In some embodiments, the first text embedding is represented by a matrix of columns and rows (e.g., the matrix 302 or 502), each column represents a distribution of tokens, and wherein the periodic weighted factor changes one or two columns and leaves the rest of the columns unchanged in the matrix when generating the second text embedding, and wherein the changing of one or more two columns is indicative of changing one or two words in the first text embedding. Examples of this are described in the output matrix 506 of FIG. 5. In some embodiments, each column represents a token or word in the sequence and each row represents the dimensions of the embedding space for a particular token, capturing various semantic and syntactic features. Each column's values represent the distribution over possible tokens, encapsulating how likely each token is to be the correct or intended one in that position based on the model's predictions. By changing these columns, the model effectively alters the prediction or representation for those particular words, refining the generated text or correcting it towards more desired outputs.

In some embodiments, the changing at block 911 is based on using an energy-based model that minimizes an energy function for the changing of the first text embedding to the second text embedding, and wherein the minimizing the energy function includes generating natural language text that optimized for a metric while remaining fluent. Examples of this are described with respect to the energy-based model 216 and the energy-based sampling 304 of FIG. 3. Accordingly, an energy-based model (EBM) assigns an energy score to each possible configuration of variables—in this case, text embeddings. The lower the energy, the more preferable the configuration. The energy function E(y˜) in some embodiments includes terms that account for both the optimization metric (e.g., engagement score) and fluency constraints (e.g., language coherence).

In some embodiments, the changing of the first text embedding to the second text embedding at block 911 is further based on training a value model to predict, via a scoring function, metric scores with text as input and taking gradients of the scoring function with an additional fluency constraint. Examples of this are described with respect to FIG. 8, FIG. 6, and the metric value model 214 of FIG. 2. The value model is trained to predict metric scores based on given text sequences. These metrics could include engagement scores, user ratings, click-through rates, etc. In some embodiments the value model is trained using a dataset of text sequences paired with their respective metric scores, providing a foundation for learning how different text features correlate with these scores. Regarding the scoring function, once trained, the value model provides a scoring function that assigns a metric score to any input text sequence. This score indicates how well the text is expected to perform according to the specific metric. Various embodiments then Change Text Embeddings Using Gradients. Initial Text Embedding (y⁻⁽⁰⁾) represents the initial state of the text, capturing its current semantic and syntactic characteristics. The value model predicts a score for the text based on its current embedding. This score helps in evaluating how well the text aligns with the desired metric (e.g., engagement). The gradients of the scoring function with respect to the text embeddings are computed. These gradients show how changes in the embeddings will affect the metric score. In some embodiments, the formula for gradient calculation is represented as:

$${∇}_{y ∼} S = \frac{\partial Score}{\partial y ∼}$$

where S denotes the score function output by the value model.

In some embodiments, a fluency constraint is implemented using KL divergence (as described above), comparing the predicted distribution of the next word with reference distributions (anchor points). This ensures the generated text remains coherent and fluent. The fluency constraint is added to the gradients from the scoring function, resulting in a combined gradient that balances metric optimization with maintaining natural language fluency. In some embodiments, the combined gradient can be represented as:

$${∇}_{y ∼} E = {∇}_{y ∼} S + λ {\sum }_{i = 1}^{N} {\sum }_{t = 0}^{N} ∇ y ∼ KL ( Ppredicted ( v \vert context ) \vert \vert Perference ( v \vert context ) )$$

Various embodiments perform Gradient Descent by updating embeddings. The text embeddings are updated by moving them in the direction that decreases the energy function, which includes both the metric score and the fluency constraint, for example:

$${y}^{∼ ( n + 1 ) =} {y}^{∼ ( n ) -} η {∇}_{y ∼} E$$

where η is the learning rate. This process is repeated iteratively, adjusting the text embeddings to minimize the energy function, thus optimizing the text for the desired metric while ensuring fluency.

In an illustrative example, the initial text is “The quick brown fox.” The desired metric is an engagement Score (e.g., maximizing clicks or shares). The value model scores the text based on the initial embedding, assessing its likely performance in terms of engagement. Gradients of the scoring function are then computed, indicating how changes to the embedding will affect the engagement score. Gradients are adjusted to include a fluency constraint, ensuring that changes maintain the text's coherence. The text embeddings are changed or updated, perhaps changing “quick” to “fast” or “fox” to “animal,” to optimize for engagement while remaining fluent. The final text might be “The fast brown animal,” optimized to perform better in terms of the desired metric and still sounding natural. The process involves using a value model to predict metric scores for text sequences. Gradients of the scoring function, along with a fluency constraint, guide the update of the text embeddings from their initial to final state. This approach ensures that the generated text is optimized for specific metrics while maintaining natural language fluency.

### Example Experimental Result Charts

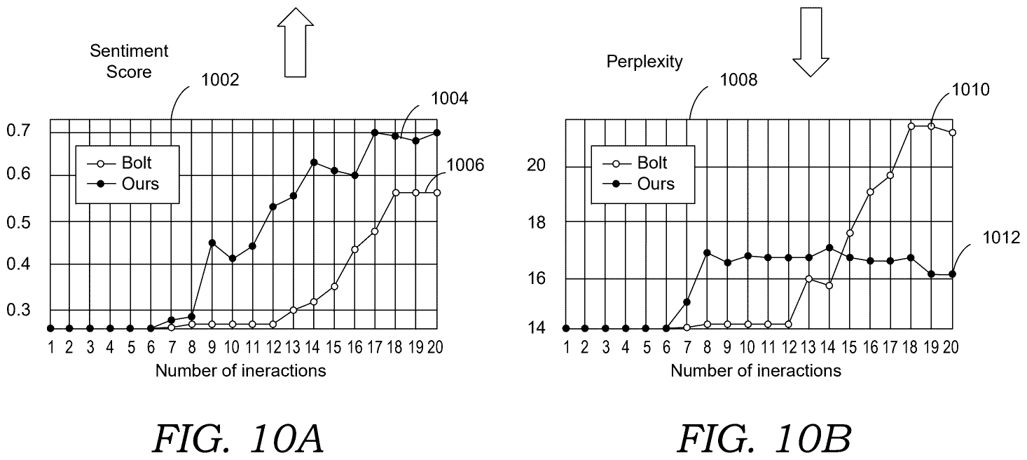

FIG. 10A is a chart 1002 illustrating improvements over existing technologies with respect to sentiment metrics, according to some embodiments. The inventors have performed experiments regarding aspects of the present disclosure (labeled as “Ours”) in comparison to existing technologies (labeled as “BOLT”). The dataset used for this experiment was an internal dataset for email generation where the aim was to generate an email that had both positive sentiment (indicated in the chart 1002) and had natural language fluency (indicated in the chart 1008). The Y-Axis represents the sentiment score and the X-Axis represents the number of iterations. The number of iterations typically refers to the number of times the optimization process has been performed or the number of times the model parameters have been updated. Each iteration usually involves adjusting the model based on a set of data to improve performance according to the defined metrics (e.g., engagement score, fluency). In some embodiments, the “number of iterations” represent the number of training epochs or steps taken to refine the model's parameters using the training data. In the context of an energy-based model, “iterations” in some embodiments refers to the steps taken during the optimization process to minimize the energy function. This involves computing gradients, applying updates to the embeddings, and gradually refining the text outputs to improve according to the specified metrics. In some embodiments, the iterations additionally or alternatively indicate the number of evaluations or checks performed to assess the model's performance at different stages of training or optimization. This helps in monitoring progress and understanding how well the model is learning.

As illustrated in FIG. 10A, The “Ours” line 1004 shows a consistent increase in the sentiment metric value starting from around the 7th iteration, eventually surpassing the “BOLT” line. This indicates that various embodiments of the invention become more effective than BOLT after a certain number of iterations, achieving a higher metric score.

FIG. 10B is a chart 1008 illustrating improvements over existing technologies with respect to perplexity or natural language fluency, according to some embodiments. The inventors have performed experiments regarding aspects of the present disclosure (labeled as “Ours”) in comparison to existing technologies (labeled as “BOLT”). The dataset used for this experiment was an internal dataset for email generation where the aim was to generate an email that had both positive sentiment (indicated in the chart 1002) and had natural language fluency (indicated in the chart 1008). The Y-Axis represents the perplexity score (the higher the value, the more perplex and less fluent) and the X-Axis represents the number of iterations.

As illustrated in FIG. 10A, the “Ours” line 1012 initially increases rapidly and then stabilizes, while the “BOLT” line 1010 eventually surpasses the “Ours” line 1010 in perplexity. This indicates that while embodiments of the invention are not as fluent initially (up until the 14th iteration), the BOLT method eventually catches up and surpasses it in perplexity after more iterations. By the end of the 20th iteration, the BOLT method is much less fluent and more perplex relative to “ours.” Therefore, both FIGS. 10A and 10B illustrate that various embodiments of the present disclosure generate text that is both fluent (chart 1008) and likely to meet particular metrics (chart 1002), improving existing technologies in both respects.

### Exemplary Operating Environments

Turning now to FIG. 11, a schematic depiction is provided illustrating an example computing environment 1100 for recommending one or more color values for applying to an input image, in which some embodiments of the present invention may be employed. It should be understood that this and other arrangements described herein are set forth only as examples. Other arrangements and elements (e.g., machines, interfaces, functions, orders, groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. For example, there may be multiple servers 1110 that represent nodes in a cloud computing network. Various functions described herein as being performed by one or more entities may be carried out by hardware, firmware, and/or software. For instance, various functions may be carried out by a processor executing instructions stored in memory.

The environment 1100 depicted in FIG. 11 includes a prediction server (“server”) 1110 that is in communication with the network 10. The environment 1100 further includes a client device (“client”) 1120 that is also in communication with the network 210. Among other things, the client 1120 can communicate with the server 1110 via the network 210, and generate for communication, to the server 1110, a request to make a detection, prediction, or classification of one or more instances of a document/image. The request can include, among other things, a request to perform video object segmentation. In various embodiments, the client 1120 is embodied in a computing device, which may be referred to herein as a client device or user device, such as described with respect to the computing device 12 of FIG. 12.

In some embodiments, each component FIG. 1 is included in the server 1110 or the client device 1120. Alternatively, in some embodiments, the components in FIG. 1 are distributed between the server 1110 and client device 1120.

The server 1110 can receive the request communicated from the client 1120, and can search for relevant data via any number of data repositories to which the server 1110 can access, whether remotely or locally. A data repository can include one or more local computing devices or remote computing devices, each accessible to the server 1110 directly or indirectly via network 210. In accordance with some embodiments described herein, a data repository can include any of one or more remote servers, any node (e.g., a computing device) in a distributed plurality of nodes, such as those typically maintaining a distributed ledger (e.g., block chain) network, or any remote server that is coupled to or in communication with any node in a distributed plurality of nodes. Any of the aforementioned data repositories can be associated with one of a plurality of data storage entities, which may or may not be associated with one another. As described herein, a data storage entity can include any entity (e.g., retailer, manufacturer, e-commerce platform, social media platform, web host) that stores data (e.g., names, demographic data, purchases, browsing history, location, addresses) associated with its customers, clients, sales, relationships, website visitors, or any other subject to which the entity is interested. It is contemplated that each data repository is generally associated with a different data storage entity, though some data storage entities may be associated with multiple data repositories and some data repositories may be associated with multiple data storage entities. In various embodiments, the server 1110 is embodied in a computing device, such as described with respect to the computing device 1200 of FIG. 12.

Having described embodiments of the present invention, an exemplary operating environment in which embodiments of the present invention may be implemented is described below in order to provide a general context for various aspects of the present invention. Referring initially to FIG. 12 in particular, an exemplary operating environment for implementing embodiments of the present invention is shown and designated generally as computing device 1200. Computing device 1000 is but one example of a suitable computing environment and is not intended to suggest any limitation as to the scope of use or functionality of the invention. Neither should the computing device 1000 be interpreted as having any dependency or requirement relating to any one or combination of components illustrated.

Looking now to FIG. 12, computing device 1200 includes a bus 10 that directly or indirectly couples the following devices: memory 12, one or more processors 14, one or more presentation components 16, input/output (I/O) ports 18, input/output components 20, and an illustrative power supply 22. Bus 10 represents what may be one or more buses (such as an address bus, data bus, or combination thereof). Although the various blocks of FIG. 12 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. The inventor recognizes that such is the nature of the art, and reiterates that the diagram of FIG. 12 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 12 and reference to “computing device.”

Computing device 1200 typically includes a variety of computer-readable media. Computer-readable media can be any available media that can be accessed by computing device 1200 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 1200. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media. In various embodiments, the computing device 1200 represents the client device 1120 and/or the server 1110 of FIG. 11.

Memory 12 includes computer-storage media in the form of volatile and/or nonvolatile memory. The memory may be removable, non-removable, or a combination thereof. Exemplary hardware devices include solid-state memory, hard drives, optical-disc drives, etc. Computing device 1200 includes one or more processors that read data from various entities such as memory 12 or I/O components 20. Presentation component(s) 16 present data indications to a user or other device. Exemplary presentation components include a display device, speaker, printing component, vibrating component, etc. In some embodiments, the memory includes program instructions that, when executed by one or more processors, cause the one or more processors to perform any functionality described herein, such as the process 1000 of FIG. 10, or any functionality described with respect to FIGS. 1 through 11.

I/O ports 18 allow computing device 1200 to be logically coupled to other devices including I/O components 20, some of which may be built in. Illustrative components include a microphone, joystick, gamepad, satellite dish, scanner, printer, wireless device, etc. The I/O components 20 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1200. The computing device 1200 may be equipped with depth cameras, such as stereoscopic camera systems, infrared camera systems, RGB camera systems, touchscreen technology, and combinations of these, for gesture detection and recognition. Additionally, the computing device 1200 may be equipped with accelerometers or gyroscopes that enable detection of motion. The output of the accelerometers or gyroscopes may be provided to the display of the computing device 1200 to render immersive augmented reality or virtual reality.

As can be understood, embodiments of the present invention provide for, among other things, generating proof and attestation service notifications corresponding to a determined veracity of a claim. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub combinations are of utility and may be employed without reference to other features and sub combinations. This is contemplated by and is within the scope of the claims.

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A system comprising:
at least one computer processor; and
one or more computer storage media storing computer-useable instructions that, when used by the at least one computer processor, cause the at least one computer processor to perform operations comprising:
accessing a dataset that includes a first set of natural language sequences and a respective metric associated with each natural language sequence, of the first set of natural language sequences;
based on the first set of natural language characters and the respective metric associated with each natural language sequence, generating, via a language model, a batch of natural language sequences;
encoding the batch of natural language sequences into a first text embedding that at least partially represents the batch natural language sequences;
for at least one word of each natural language sequence of the batch of natural language sequences computing a degree of deviation between a predicted distribution of a next word and a plurality of anchor points, each anchor point representing a reference distribution generated by the language model for maintaining natural language fluency; and
based on at least one metric of the respective metric and the degree of deviation between the predicted distribution of the next word and the plurality of anchor points, changing the input text embedding into a second text embedding.

2. The system of claim 1, wherein the changing is based on assigning a low gradient to most positions in the first text embedding and introducing a periodic weighted factor that controls the changing at each position of the first text embedding when generating the second text embedding.

3. The system of claim 2, wherein the first text embedding is represented by a matrix of columns and rows, each column represents a distribution of tokens, and wherein the periodic weighted factor changes one or two columns and leaves the rest of the columns unchanged in the matrix when generating the second text embedding, and wherein the changing of one or more two columns is indicative of changing one or two words in the first text embedding.

4. The system of claim 1, wherein the computing of the degree of deviation between the predicted distribution of the next word and the plurality of anchor points is based on computing batched Kullback-Leibler (KL) Divergence, and wherein the degree of deviation is computed using KL divergence for each context t and each natural language sequence i in the batch, and wherein the batched KL divergence is an average or sum of the KL divergences across all of the natural language sequences and positions in the batch of natural language sequences.

5. The system of claim 1, wherein the respective metric associated with each natural language sequence includes at least one of: a sentiment value, an attractiveness value, a popularity value, a quantity of clicks, a click-through rate (CTR), a conversion rate, an open rate, engagement time, a bounce rate, social media shares and likes, an email response rate, a form completion rate, and a user feedback and rating.

6. The system of claim 1, wherein the changing is based on using an energy-based model that minimizes an energy function for the changing of the first text embedding to the second text embedding, and wherein the minimizing the energy function includes generating natural language text that optimized for a metric while remaining fluent.

7. The system of claim 1, wherein each natural language sequence of the batch of natural language sequences represents a respective sentence.

8. The system of claim 1, wherein the generating of the batch of natural language sequence is based on computing, via a value model, a metric score for each natural language sequence of the batch of natural language sequences the metric score being indicative of how well a respective natural language sequence of the batch of natural language sequences is expected to perform according to a given metric, and wherein the changing of the first text embedding to the second text embedding is further based on the metric score.

9. The system of claim 1, wherein the changing of the first text embedding to the second text embedding is further based on training a value model to predict, via a scoring function, metric scores with text as input and taking gradients of the scoring function with an additional fluency constraint.

10. A computer-implemented method comprising:
encoding a plurality of natural language sequences into a first text embedding that at least partially represents the plurality of natural language sequences;
computing, via a value model, a metric score for each natural language sequence, of the plurality of natural language sequences, the metric score being indicative of how well a respective natural language sequence is expected to perform according to a given metric;
use a periodic weighted factor that controls a change at each position of the first text embedding; and
based on the computing of the metric score for each natural language sequence, of the plurality of natural language sequences and the introducing of the periodic weighted factor, changing at least one natural language sequence, of the plurality of natural language sequences, by changing at least one word.

11. The computer-implemented method of claim 10, wherein the first text embedding is represented by a matrix of columns and rows, each column represents a distribution of tokens, and wherein the periodic weighted factor changes one or two columns and leaves the rest of the columns unchanged in the matrix, and wherein the changing of one or more two columns is indicative of the changing of the at least one natural language sequence.

12. The computer-implemented method of claim 10, wherein the changing is further based on computing a degree of deviation between a predicted distribution of a next word and a plurality of anchor points, each anchor point representing a reference distribution generated by the language model for maintaining natural language fluency.

13. The computer-implemented method of claim 12, wherein the computing of the degree of deviation between the predicted distribution of the next word and the plurality of anchor points is based on computing batched Kullback-Leibler (KL) Divergence, and wherein the degree of deviation is computed using KL divergence for each context t and each natural language sequence i, and wherein the batched KL divergence is an average or sum of the KL divergences across all of the natural language sequences and positions in the plurality of natural language sequences.

14. The computer-implemented method of claim 10, wherein the given metric includes at least one of: a sentiment value, an attractiveness value, a popularity value, a quantity of clicks, a click-through rate (CTR), a conversion rate, an open rate, engagement time, a bounce rate, social media shares and likes, an email response rate, a form completion rate, and a user feedback and rating.

15. The computer-implemented method of claim 10, wherein the changing is further based on using an energy-based model that minimizes an energy function for the changing of the first text embedding to a second text embedding, and wherein the minimizing the energy function includes generating natural language text that optimized for a metric while remaining fluent.

16. The computer-implemented method of claim 10, wherein each natural language sequence, of the plurality of natural language sequences, represents a respective sentence.

17. The computer-implemented method of claim 10, further comprising training the value model to predict, via a scoring function, metric scores with text as input and taking gradients of the scoring function with an additional fluency constraint.

18. A system comprising:
a language model means for receiving a metric value model as a scoring function and a text prompt as input, the language model generating a set of candidate text sequences;
wherein the language model means is further for converting the candidate text sequences into a text embedding; and
an energy-based model means for changing the text embedding based on at least one of: taking gradients of the scoring function with one or more constraints or using a periodic weighted factor to control whether there is a change at each token position of the text embedding.

19. The system of claim 18, further comprising:
a metric value model means for providing the metric value model a dataset as input into the metric value model, wherein the metric value model predicting one or more metric scores.

20. The system of claim 18, wherein the dataset include text-metric score pair scores.
